(19) United States
(12) Patent Application Publication
(10) Pub. No.: US 2010/0307509 A1
(43) Pub. Date: Dec. 9, 2010

(54) POSITIONING DEVICE FOR USE WITH A PATIENT UNDER ANESTHESIA AND ASSOCIATED METHODS

(76) Inventors: APRIL CHRISTINE KING, Cardiff by the Sea, CA (US); Adrian Pelkus, Escondido, CA (US); William J. Mazzei, San Diego, CA (US); Warren Gee Young, San Diego, CA (US)

Correspondence Address: SHEPPARD, MULLIN, RICHTER & HAMPTON LLP, 12275 EL CAMINO REAL, SUITE 200, SAN DIEGO, CA, 92130, US

(21) Appl. No.: 12/789,151

(22) Filed: May 27, 2010

Related U.S. Application Data
(63) Continuation-in-part of application No. 12/209,003, filed on Sep. 11, 2008.

(51) Int. Cl. A61G 15/12

(52) U.S. Cl. 128/845

(57) ABSTRACT

The present invention provides devices for use with a patient under anesthesia and associated methods. Various embodiments of the present invention include a device for establishing and maintaining a patient's head and/or jaw in a particular position, including the sniffing position.

### CROSS REFERENCE TO RELATED APPLICATIONS

This application claims priority to U.S. Utility patent application Ser. No. 12/209,003 filed Sep. 11, 2008, which is hereby incorporated herein by reference in its entirety.

### FIELD OF THE INVENTION

The invention relates to surgical devices for positioning a patient, including a patient under general anesthesia or sedation, and in some embodiments to surgical devices for establishing and maintaining a patient's head and/or jaw in a particular position.

### BACKGROUND OF THE INVENTION

Millions of surgeries and invasive diagnostic procedures are performed in the United States every year. Most, if not all, of these surgeries and procedures involve the use of some form of anesthesia or sedation. In some cases, general anesthesia is used that renders the patient unconscious. Generally, before and/or during such surgeries, a doctor (an “anesthesiologist” or an “oral surgeon”) and/or Certified Registered Nurse Anesthetist administers the anesthetics and monitors the patient while the patient is under anesthesia or sedation.

The job of the anesthesiologist or anesthetist is not a simple one. With modern anesthesia, a wide variety of medical equipment may be used. Anesthesia practitioners must possess a comprehensive and intricate knowledge of the use of various medical gases, anesthetic agents and vapors, medical breathing circuits and the variety of anesthetic machines (e.g., vaporizers, ventilators and pressure gauges) and their corresponding safety features, hazards and limitations. Moreover, a patient being treated under general anesthetics must be monitored continuously to ensure the patient's safety. For minor surgery, this generally includes monitoring of things such as heart rate, oxygen saturation, non-invasive blood pressure, inspired and expired gases (for oxygen, carbon dioxide, nitrous oxide, and volatile agents). For moderate to major surgery, monitoring may also include temperature, urine output, invasive blood pressure measurements, pulmonary artery pressure and pulmonary artery occlusion pressure, cerebral activity, neuromuscular function, and cardiac output. The various pieces of equipment and considerations can keep an anesthesiologist or anesthetist quite occupied before, during and after a surgical procedure.

Not surprisingly, an important consideration while a patient is under sedation or general anesthesia is insuring the patient can breathe properly. In some instances physically invasive methods, such as the insertion of tubes, are required. It has been shown, however, that positioning of the patient plays a role in ensuring the patient can breathe properly. For example, placing and keeping a patient in certain positions (e.g., the “sniffing” position) helps to ensure that a patient's airways is not obstructed. Thus, positioning of the patient is another condition that an anesthesiologist or anesthetist may need to monitor during a procedure. Therefore a method or device that aids the placing of a patient in a position that facilitates breathing and/or maintains the patient in that position during a procedure may ease the burden on an attending anesthesia practitioner before, during and after a surgical or similar procedure. Such a method or device may have broad applications in medicine and dentistry, including any situation where a patient is unconscious and/or immobilized whether or not that patient is under anesthesia.

### SUMMARY OF THE INVENTION

In some embodiments, embodiments of the apparatus and methods disclosed herein include a device including: a base comprising a first side and a second side, wherein the base is configured to substantially accommodate a patient's head; a first support positioned on the first side of the base; a second support positioned on the second side of the base; a first mandible arm positioned on the first support, wherein the first mandible arm is configured to contact a patient's jaw; a second mandible arm positioned on the second support, wherein the second mandible arm is configured to contact a patient's jaw; wherein the first mandible arm and the second mandible arm are movable in three axes such that each is positionable to be in contact with a patient's jaw and to maintain a patient in a desired position. The device, in some embodiments, can be configured such that the mandible pads and the base can be configured to provide support for a patient for one or more of flexion of the cervical spine, extension of the head, and anterior displacement of the mandible.

In certain embodiments, the base is rectangular. In some embodiments, the mandible arm is positionable to be in contact with a patient's jaw at three points. In further embodiments, the first mandible arm and the second mandible arm each include a mandible pad. In yet further embodiments, the first mandible arm and the second mandible arm are removably connected to the first support and the second support, respectively. In other embodiments, the first mandible aim is movable relative to the first support and the second mandible arm is movable relative to the second support. In some embodiments, the three axes are the x, y and w axes relative to the patient. In various embodiments, the desired position is the sniffing position.

In certain embodiments, the mandible pad comprises foam. In further embodiments, the mandible arm is positionable such that the mandible pad is in contact with a patient's jaw at one or more points. In some embodiments, the mandible arm is positionable such that the mandible pad is in contact with a patient's jaw at three points. In yet other embodiments, the first support is movable relative to the base and the second support is movable relative to the base. In various embodiments, the first support is movable relative to the base in two axes and the second support is movable relative to the base in two axes. In some embodiments, the first support is movable relative to the base in three axes and the second support is movable relative to the base in three axes. In other embodiments, the first support is movable relative to the first mandible arm and the second support is movable relative to the second mandible arm.

In other embodiments of the apparatus and methods disclosed herein a device includes: a base comprising a plurality of supports, wherein the base is configured to substantially accommodate a patient's head, wherein each support comprises a mandible arm, wherein each mandible arm is configured to contact a patient's jaw; and wherein each mandible arm is movable in three axes such that each mandible arm is positionable to be in contact with a patient's jaw and to maintain a patient in a desired position. In certain embodiments, the base is rectangular. In other embodiments, each mandible arm is positionable to be in contact with a patient's jaw at three points. The device, in some embodiments, can be configured such that the mandible pads and the base can be configured to provide support for a patient for one or more of flexion of the cervical spine, extension of the head, and anterior displacement of the mandible.

In further embodiments, each mandible arm comprises a mandible pad. In yet further embodiments, each mandible arm is removably connected to each support. In some embodiments, each mandible arm is movable relative to a support. In other embodiments, the three axes are the x, y and w axes relative to the patient. In yet other embodiments, the desired position is the sniffing position. In various embodiments, each mandible pad includes foam. In certain embodiments, each mandible arm is positionable such that the mandible pad is in contact with a patient's jaw at one or more points. In certain embodiments, each mandible arm is positionable such that the mandible pad is in contact with a patient's jaw at three points. In further embodiments, each support is movable relative to the base. In yet further embodiments, each support is movable relative to the base in two axes. In other embodiments, each support is movable relative to the mandible arms.

Other embodiments of the apparatus and methods disclosed herein include methods. The method may be a method for positioning a patient including the steps of: providing any embodiment of the devices of the present invention, placing the patient's head substantially on the base of the device; placing the patient's head in a desired position; moving a first mandible arm to contact the patient's jaw; moving a second mandible arm to contact the patient's jaw; wherein the contact of the first mandible arm and the second mandible arm provides sufficient force to substantially maintain the patient's head and/or jaw in a desired position. In some embodiments, placing the patient's head on the base and adjusting the mandible arms can be performed so as to provide flexion of the cervical spine, extension of the head, and anterior displacement of the mandible.

In yet other embodiments, a mandible arm includes: a curved portion, wherein the curved portion is substantially rigid; a mandible pad, wherein the mandible pad is flexible, and wherein the mandible pad has a distal side configured to attach to the curved portion and a proximal side configured to contact a patient's jaw at a plurality of points; and a connector portion wherein the connector portion is configured to attach to a support. In some embodiments, the mandible arm may be adapted to work with any embodiment of the devices of the present invention. In other embodiments, the mandible pad comprises foam. In yet other embodiments, the connector portion is configured to attach to a support that is attached to a base comprising a right side and a left side, wherein the base is configured to substantially accommodate a patient's head, and wherein the support is movable in three axes such that the mandible pad is positionable to be in contact with a patient's jaw at one or more points and to maintain a patient in a desired position.

In still other embodiments, a device includes: a first support comprising an insertion portion dimensioned to permit insertion into a first recess in a base, an extension portion extending from the insertion portion, and a connector disposed on the insertion portion; a first key structure disposed on the connector; a second support positioned on the second side of the base and comprising an insertion portion dimensioned for insertion into a second recess in a base, an extension portion extending from the insertion portion, and a connector disposed on the insertion portion; a second key structure disposed on the connector; a first mandible arm removably connected to the connector of the first support and comprising a first complementary key structure wherein the first complementary key structure is complementary to the first key structure so that the first mandible arm cannot be connected to the connector on the second support; and a second mandible arm removably connected to the connector of the second support and comprising a second complementary key structure, wherein the second complementary key structure is complementary to the second key structure so that the second mandible arm cannot be connected to the connector on the first support.

The device can further include the base, wherein the base comprises a top portion, an upper side, a lower side a right side and a left side, and the first recess formed in the right side and the second recess formed in the left side. Additionally, the first support is, in some embodiments, movable relative to the base and the second support is movable relative to the base. For example, the first support can be movable relative to the base in two or three axes and the second support can be movable relative to the base in two or three axes. The first support can also be movable relative to the first mandible arm and the second support can be movable relative to the second mandible arm.

In various embodiments, the first and second mandible arms are positionable to be in contact with a patient's jaw at three points. Further, the first mandible arm and the second mandible arm can each further include a mandible pad. The mandible pad, in various embodiments comprises foam, plastic, or resin and can be fixedly or removably affixed to the mandible arm.

In some embodiments, the first and second key structures on the mandible arms each comprise a semicircular prism extending from a body of the mandible arm and dimensioned so as to be connectable to a support structure having a receptor structure complementary to the key structure. Additionally, the key structure can further include an elongated ridge disposed on a flat surface of the semicircular prism. A tubing grip disposed on the mandible arm can be included to retain medical tubing.

In still a further embodiment, a mandible arm includes: a curved body portion having first and second opposed surfaces, a first end and a second end; an arm portion extending from the first surface, the arm portion comprising a semicircular prism portion dimensioned so as to be connectable to a support structure having a complementary structure; and a mandible pad attached to the second surface of the curved body portion. In some embodiments, the mandible arm further includes a key structure disposed on the arm portion, wherein the key structure is dimensioned such that the mandible arm can only be connected to a support structure having a complementary key structure. The key structure, for example, comprises an elongated ridge disposed on a flat surface of the semicircular prism. The mandible arm can be configured to be removably connected to the support structure. The mandible pad, in various embodiments comprises foam, plastic, or resin and can be fixedly or removably affixed to the mandible arm. A tubing grip disposed on the mandible arm can be included to retain medical tubing.

In another embodiment, the arm portion further includes a cylindrical projection extending from the first surface and the semicircular prism portion is disposed on and extends axially from the cylindrical projection and wherein the key structure comprises the semicircular ridge. In still another embodiment, the mandible arm includes a key structure disposed on the arm portion, wherein the key structure is dimensioned such that the mandible arm can only be connected to a support structure having a complementary key structure and such that the mandible arm can only be positioned on the support structure in a predetermined orientation.

In a further embodiment, the arm portion further includes a cylindrical projection extending from the first surface and the semicircular prism portion is disposed on and extends axially from the cylindrical projection. In still a further embodiment, the semicircular prism portion is further dimensioned so as to permit only selective positioning of the mandible arm relative to the support structure.

Other features and aspects of the disclosed method and apparatus will become apparent from the following detailed description, taken in conjunction with the accompanying drawings, which illustrate, by way of example, the features in accordance with embodiments of the disclosed method and apparatus. The summary is not intended to limit the scope of the claimed invention, which is defined solely by the claims attached hereto.

### BRIEF DESCRIPTION OF THE DRAWINGS

FIG. 1 is a schematic diagram providing a top view of embodiments of the present invention.

FIGS. 2A-2B are schematic diagrams providing a side view of embodiments of the present invention.

FIGS. 3A-3B are schematic diagrams of embodiments of a device of the present invention.

FIGS. 4A-4E are schematic diagrams providing multiple views of embodiments of a mandible arm and mandible pad of the present invention.

FIGS. 5A-5H are schematic diagrams providing multiple views of other embodiments of a mandible arm and mandible pad of the present invention.

FIGS. 6A-6H are schematic diagrams providing multiple views of other embodiments of a mandible arm.

FIGS. 7A and 7B are diagrams illustrating yet another embodiment for a mandible arm.

FIGS. 8A-8C are close-ups of embodiments of a support.

FIGS. 9A-9C are close-ups of another embodiment of a support.

FIG. 10A is diagram illustrating a blow-up view of embodiments of a right side second portion and third portion in accordance with one embodiment of the invention.

FIG. 10B is diagram illustrating a blow-up view of a left side second portion and third portion of embodiments of the invention.

FIG. 11 is a diagram illustrating other embodiments of a base that can be used to support a patient's head.

FIG. 12 is a schematic diagram providing a side view of embodiments of a device of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

It is understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a support” is a reference to one or more supports and includes equivalents thereof known to those skilled in the art and so forth.

Embodiments of the apparatus and methods disclosed herein include devices and methods. The devices of the present invention include devices for positioning a patient. In some embodiments, the devices may be used for positioning and/or maintaining a patient in a given position before, during and/or after a medical (including surgical), dental or diagnostic procedure. In many embodiments, the patient is under sedation or general anesthesia, and in some embodiments the patient may be rendered unconscious by general anesthesia. In some embodiments, the positioning of the patient facilitates or eases the breathing of the patient, for example by ensuring anatomical alignment of the patient's airway. The devices may position the patient in the “sniffing” position or a similar position. The devices of the present invention may, for example, allow an anesthesiologist or anesthetist place and maintain a patient in a desired position. In some embodiments the devices of the present invention permit a person to place a patient in a specific position in a quick and efficient manner. The devices may, for example, be to provide adjustment of the patient's head and neck such as by flexion of the cervical spine, extension of the head, and anterior displacement of the mandible.

The devices of the present invention have applications in both medicine and dentistry and references to a “procedure” or a “surgical procedure” refer to various medical procedures, diagnostic procedures and dental procedures, including oral surgeries, root canals, removal of teeth, and others.

The methods of the present invention include methods of positioning a patient. Some methods may include the positioning and/or maintaining of a patient in a given position before, during and/or after a surgical, diagnostic or dental procedure. Some methods of the present invention may involve the use of a device of the present invention. Some embodiments involve the positioning of a patient in a position that may ease or facilitate the breathing of the patient, for example the “sniffing” position. Some embodiments can also include adjusting the patient's head and neck such as by flexion of the cervical spine, extension of the head, and anterior displacement of the mandible. In many embodiments, the patient is under sedation or anesthesia, including a patient that is rendered unconscious by general anesthesia or sleepy after general anesthesia.

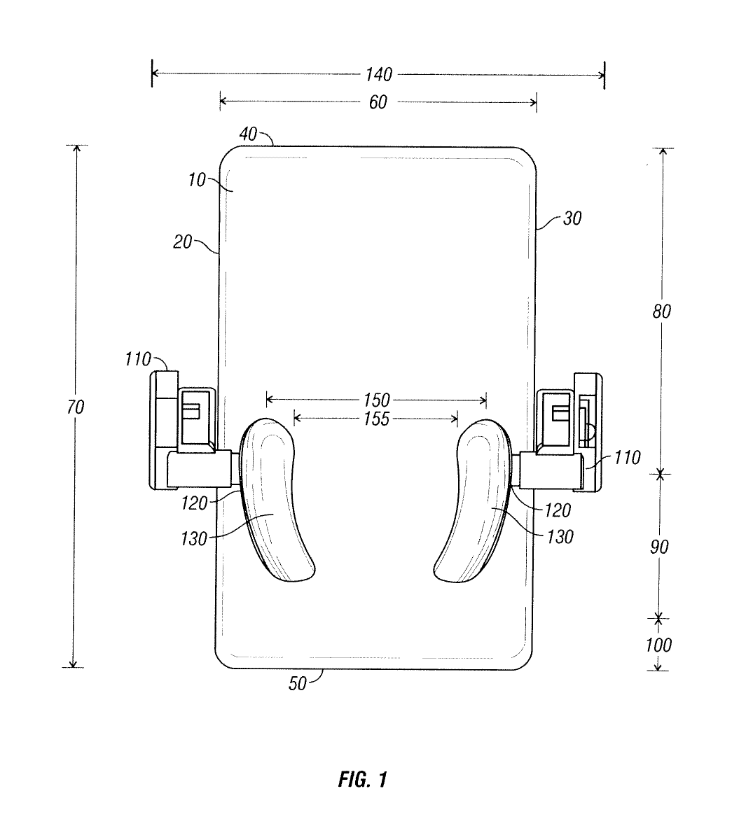

With reference to FIG. 1, an embodiment of a device of the present invention is illustrated. Base 10 is depicted as having right side 20, left side 30, upper side 40, and lower side 50. In the illustrated embodiment, base 10 is rectangular, but it may have any suitable shape. Base 10 may be made of any suitable material, including materials that are Magnetic Resonance Imaging (“MRI”) compatible, washable and/or sterilizable. In some embodiments, base 10 may be made of medical grade plastic or closed-cell foam. Base 10 may also be made of various other MRI compatible materials, including plastics, resins, resinoids, polymers, cellulose derivatives, casein materials, and metals. Base 10 may also include a cover on all or a portion of base 10. For example, such cover may be made of soft or hard foam, fabric, or cushioned material. Such materials may also be integral with a portion of base 10.

In some embodiments, base 10 may also have an alignment guide 155. Although alignment guide 155 is illustrated as an alignment line in FIG. 1, it may be any suitable structure or element. For example, alignment guide 155 may be an outline, an arrow, a notch or series of notches, an indentation, or any suitable structure. Alignment guide 155 provides a visual guide to a person attempting to place a patient in a desired position. Thus, alignment guide 155 may be movable or have multiple positions or designations that depend upon the desired position of the patient. In embodiments where alignment guide 155 is a line on base 10, the line may be approximately in line with the mandible arm 120; the patient's lip may then be placed approximately in line with the alignment guide 155. In addition, the patient is adjusted such that the mandible pad 130 may align with the patient's jaw.

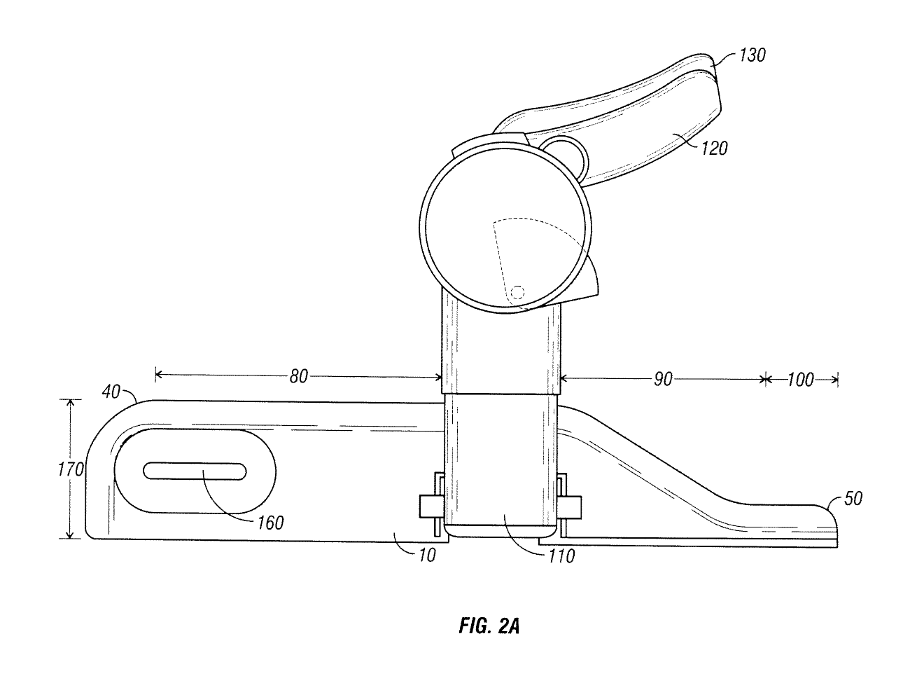

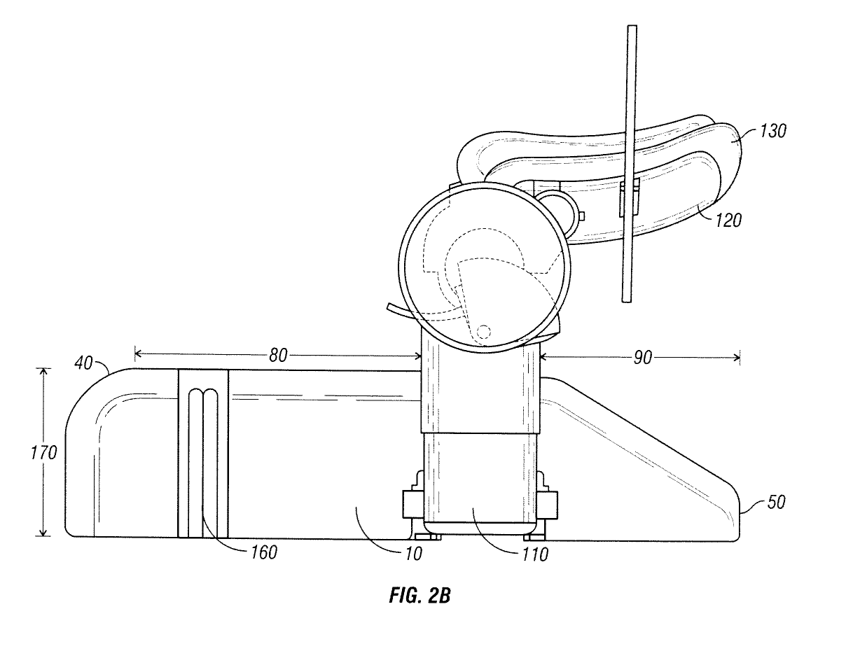

With reference to FIGS. 2A-B, gripping element 160 is also depicted. Gripping element 160 may be any suitable structure having any suitable size and configuration. For example, gripping element 160 may be a protrusion or a depression, or any other structure or texture that facilitates movement of base 10 by a person.

Returning to FIG. 1, base 10 has width 60 and length 70. Width 60 may be any suitable width and may be substantially uniform or substantially non-uniform along length 70. Generally, width 60 is sufficient to accommodate, or substantially accommodate, the width of the head of a patient. In some embodiments, width 60 may vary depending upon the intended or desired use of a particular device—for example a base 10 that is to be used for pediatric patients may have a width 60 that is less than the width 60 of a base 10 that is to be used for adult patients. In other embodiments base 10 has a width 60 that is usable with both adult and pediatric patients. In certain embodiments, width 60 may be from about three inches to about eighteen inches. In other embodiments, width 60 may be from about six to about ten inches. In further embodiments, width 60 may be about six and three quarters inches.

Similarly, length 70 may be any suitable length. Generally, length 70 is sufficient to accommodate, or substantially accommodate, the length of the head of a patient. Length 70 may also be sufficient to accommodate, or substantially accommodate, a patient's neck. In some embodiments, length 70 may vary depending upon the intended or desired use of a particular device—for example a base 10 that is to be used for pediatric patients may have a length 70 that is less than the length 70 of a base 10 that is to be used for adult patients. In other embodiments base 10 has a length 70 that is usable with both adult and pediatric patients. In certain embodiments, length 70 may be from about eight inches to about thirty-six inches. In other embodiments, length 70 may be from about twelve to about twenty-four inches. In some embodiments, length 70 may be divided into one or more zones or areas having different characteristics, including one or more of material, height, and grade (or slope). Length 70 may have any suitable number of zones having any suitable characteristics. In the illustrated embodiment, length 70 is separated into three zones: raised zone 80, sloped zone 90, and depressed zone 100.

FIG. 2A depicts a side view of right side 20 of an embodiment of the present invention. The side view better illustrates an embodiment having raised zone 80, sloped zone 90, and depressed zone 100, such that the differences in the depicted zones are more readily apparent. Raised zone 80 is generally disposed near upper side 40 and has a height 170 that is greater than the height of depressed zone 100, which is generally disposed near lower side 50. Sloped zone 90 comprises the transition from the greater height 170 of raised zone 80 to the lower height of depressed zone 100. Sloped zone 90 may have a constant or variable slope and the slope may be of any suitable magnitude. In some embodiments, raised zone 80, sloped zone 90 and depressed zone 100 are generally configured to accommodate a patient's head and neck, with sloped zone 90 approximately in line with the patient's neck. FIG. 2B shows an embodiment similar to FIG. 2A. FIG. 2B depicts an embodiment of base 10 having only a raised zone 80 and sloped zone 90.

Height 170 may be any suitable height. Preferably, height 170 is sufficient to raise a patient's head a suitable distance such that the patient's head may be placed in the “sniffing” position or such other position as may be desired, for example to provide improved, eased or consistent breathing by the patient. As discussed above, height 170 may be constant over length 70 or it may be variable. In some embodiments, height 170 may be from about one quarter of an inch to about six inches. In other embodiments, height 170 may be from about one inch to about three inches. In some embodiments the height of raised zone 80 is from about two inches to about four inches and the height of depressed zone 100 is from about one quarter of an inch to about one inch.

Returning to FIG. 1, base 10 is depicted with a support 110 on each of left side 30 and right side 20. Support 110 may be integral with base 10 or support 110 may be removable from base 10. Each support 110 is attached to a mandible arm 120 having a mandible pad 130. In some embodiments both the support width 140 and the mandible gap 150 are adjustable. Support width 140 represents the distance from the outside edge of one support 110 to the outside edge of the opposite support 110. In some embodiments, support width 140 is adjustable by movement of support 110 (or by varying the width of base 10). Support width 140 may be any suitable width, but generally is a width sufficient to accommodate the width of the head of a patient. In some embodiments, support width 140 may be from about two to about twelve inches, from about four to about eight inches, from about five to about seven inches, about eight inches, or any suitable width or range of widths. Mandible gap 150 represents the distance between the medial edge of mandible arm 120 on one side of base 10 to the medial edge of mandible arm 120 on the opposite side of base 10. In some embodiments, mandible gap 150 is adjustable by movement of support 110 and/or mandible arm 120. Mandible gap 150 may be any suitable distance, but generally is a distance sufficient to accommodate the width of a patient's jaw. In some embodiments, mandible gap 150 may be from about two to about eight inches, from about three to about six inches, from about three to about five inches, about five inches, or any suitable distance or range of distances.

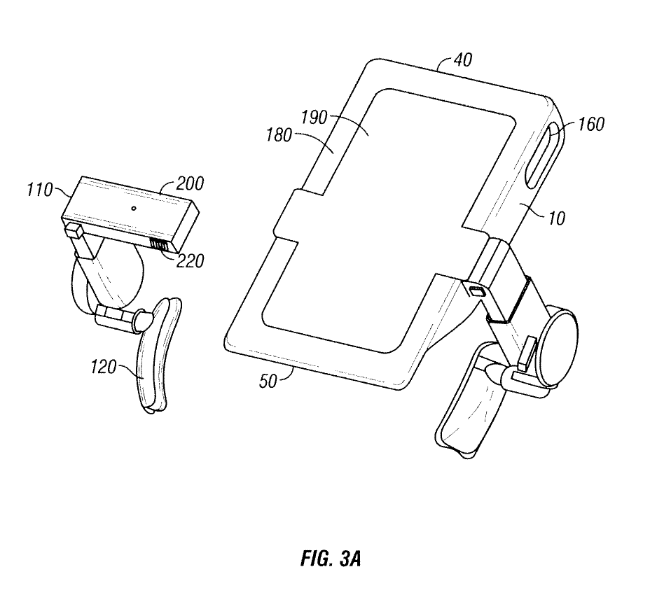

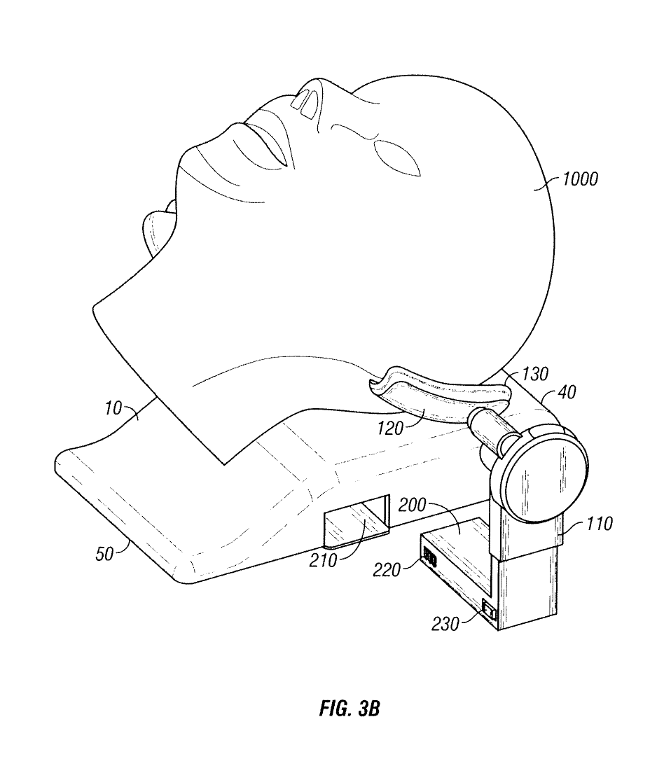

FIG. 3A illustrates a bottom view of an embodiment of a device of the present invention. FIG. 3B illustrates an auxiliary view of an embodiment of a device of the present invention. Bottom surface 180 of base 10 is depicted. In this embodiment bottom surface 180 has non-skid surface 190. Other embodiments of bottom surface 180 may not have non-skid surface 190 and may have other suitable structures or features. Non-skid surface 190 may be any surface that permits movement of base 10 when the patient is not on base 10, yet inhibits movement of base 10 when a patient is placed on base 10. Non-skid surface 190 may encompass all or only a part of bottom surface 180. For example, non-skid surface 190 may be a rubberized or tacky surface, a textured surface, or any other suitable substance or texture.

FIGS. 3A and 3B depict an embodiment having a support 110 that may be removably attached to base 10. In other embodiments, support 110 may be fixedly attached to base 10 or integral with base 10. Support 110 is illustrated having an insertion portion 200. With reference to FIG. 3B, a patient 1000 is depicted on base 10. Also illustrated is a slot 210. Insertion portion 200 is configured to fit within slot 210. In turn, slot 210 is configured to receive insertion portion 200. Although slot 210 and insertion portion 200 are depicted as rectangular, each may have any suitable shape, size or configuration. For example, slot 210 and insertion portion 200 may be cylindrical, triangular, or any other suitable shape. In addition, slot 210 and insertion portion 200 could also be a plurality of slots and/or insertion portions. For example, insertion portion 200 could comprise two rectangular portions configured to insert into a slot 210 that comprises two rectangular slots.

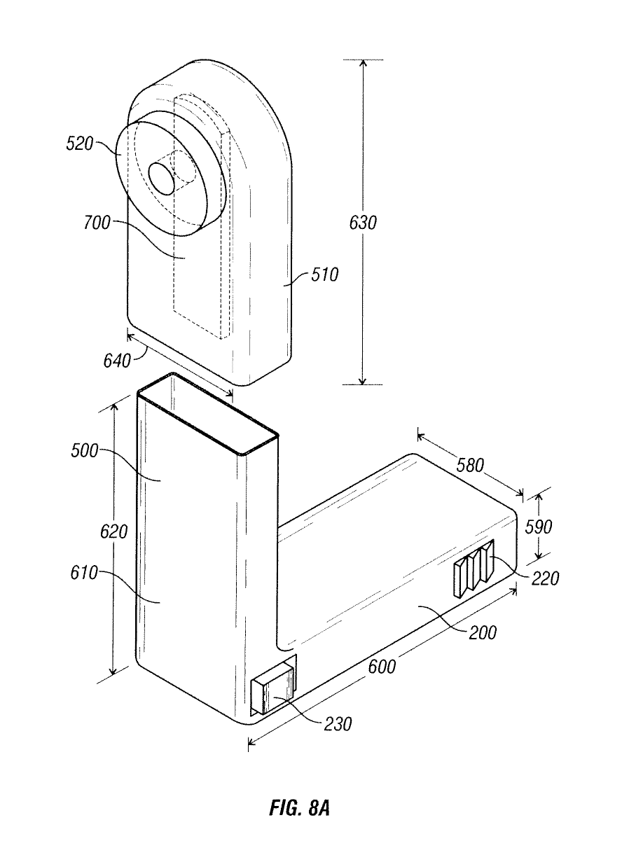

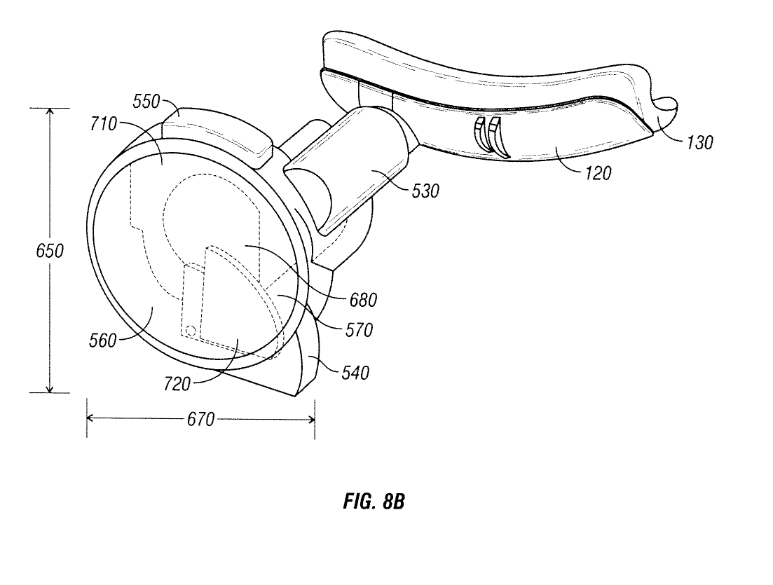

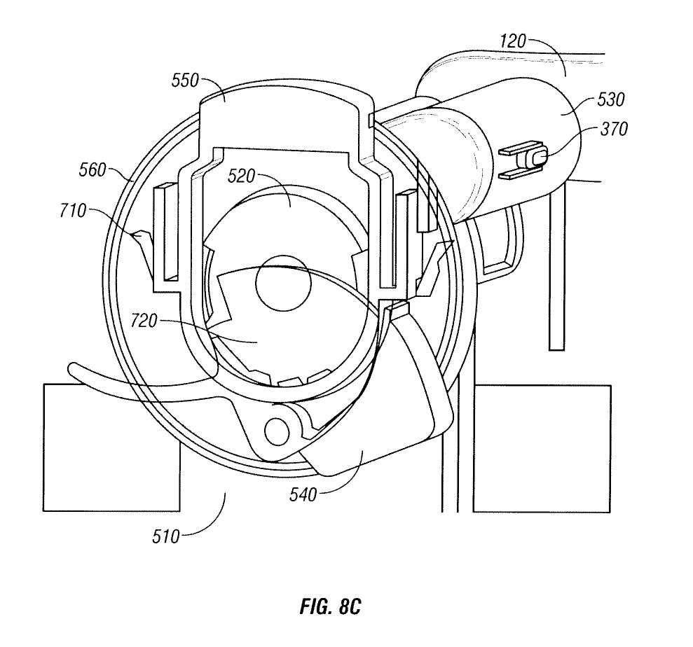

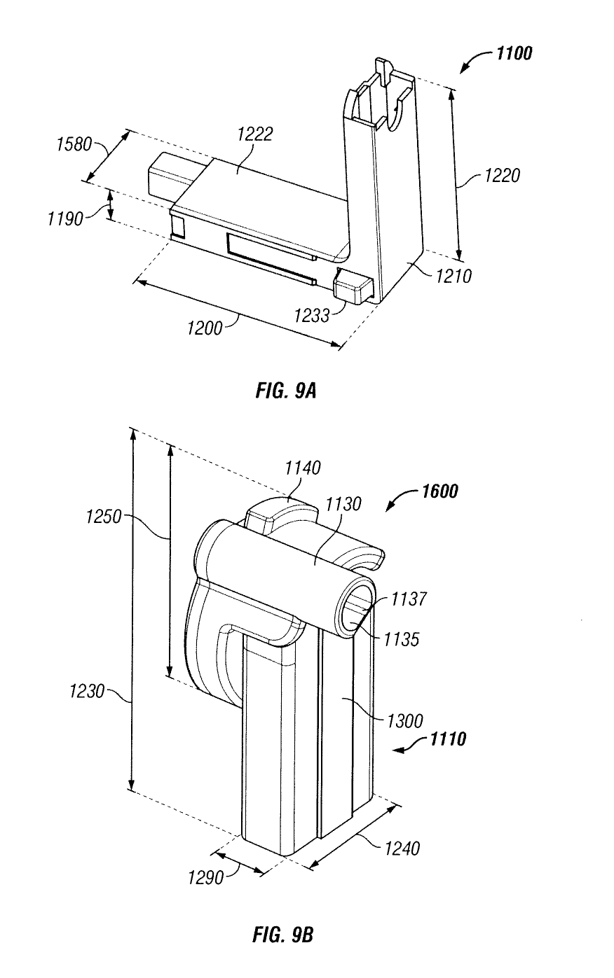

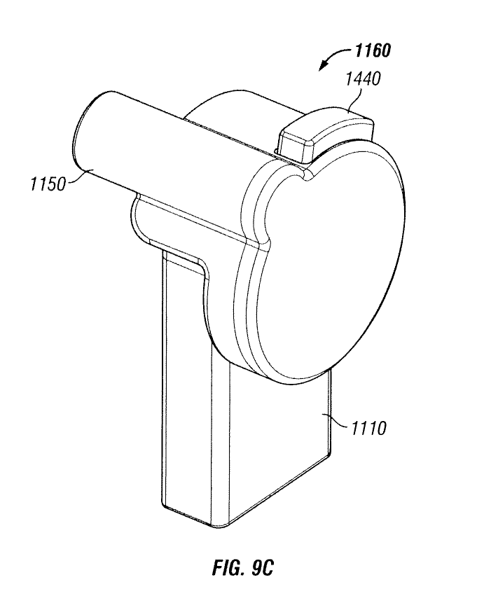

Continuing with reference to FIGS. 3A and 3B, in some embodiments insertion portion 200 has a connector 220 that is engageable with an element within slot 210 such that insertion portion 200 is locked into a position or is lockable into a variety of positions once inserted into slot 210. Connector 220 may be any suitable structure having any suitable configuration. In some embodiments, connector 220 may be a grooved structure that protrudes from insertion portion 200 such that it extends to engage an element within slot 210. In some embodiments, button 230 may be used to selectively engage/disengage (e.g., extend and/or retract) connector 220, such that insertion portion 200 may be pushed into or pulled out of slot 210 in selected increments. With reference back to FIG. 1, such movement may adjust support width 140 and/or mandible gap 150. Button 230 may be any suitable structure may be used to control the degree of insertion of insertion portion 210. Support 110 is described in greater detail with reference to FIGS. 8A-8C and 9A-9C. As these diagrams illustrate, in this example, the assembly is adjustable such that mandible arms 120 can be positioned to provide flexion of a patient's cervical spine, extension of the patient's head, and anterior displacement of the patient's mandible.

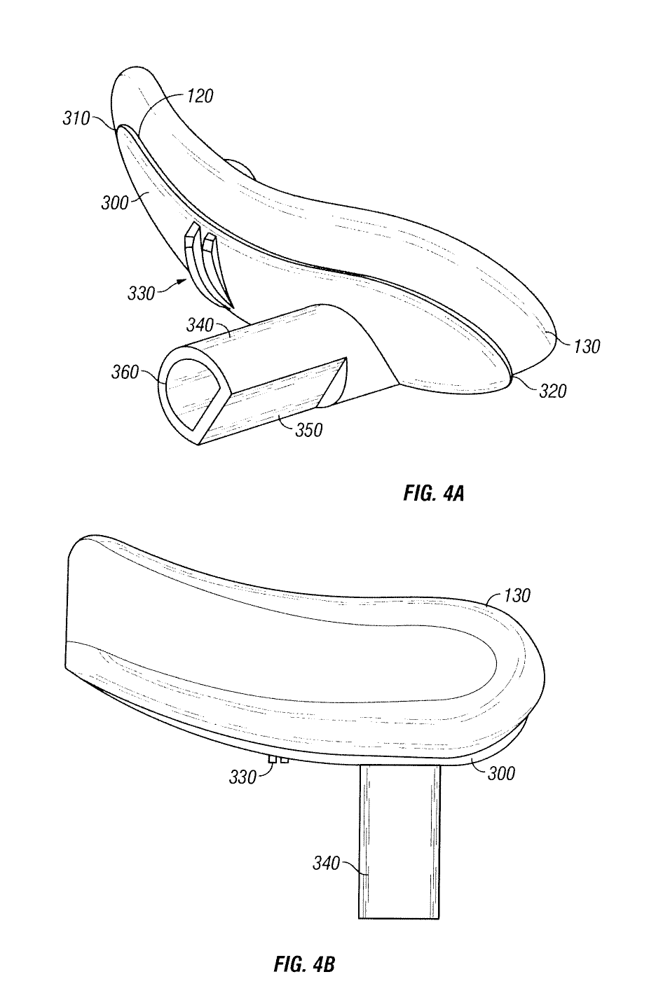

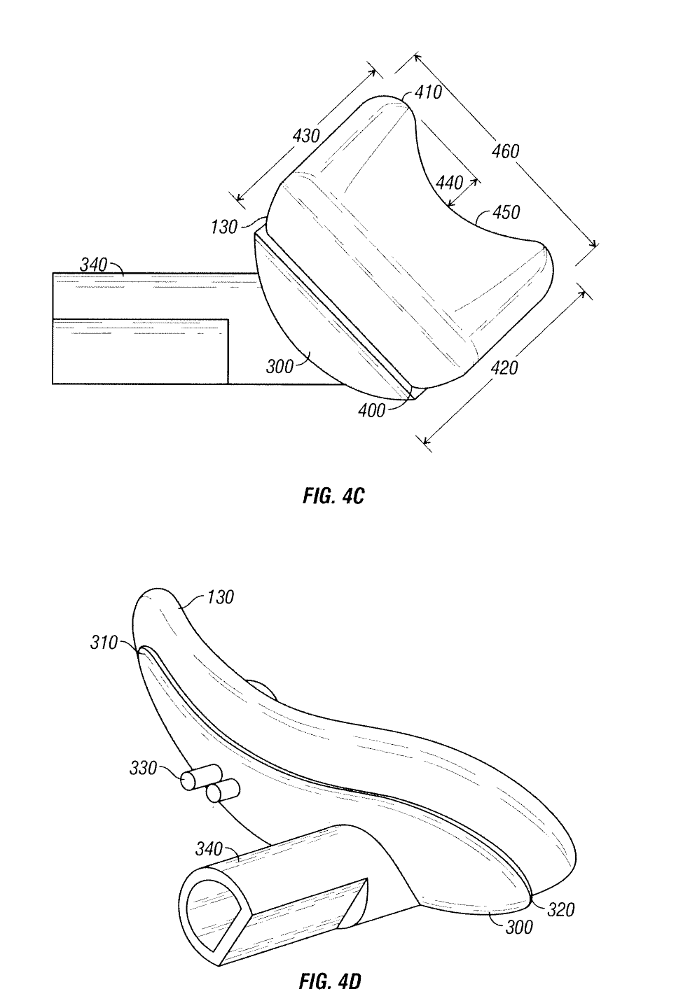

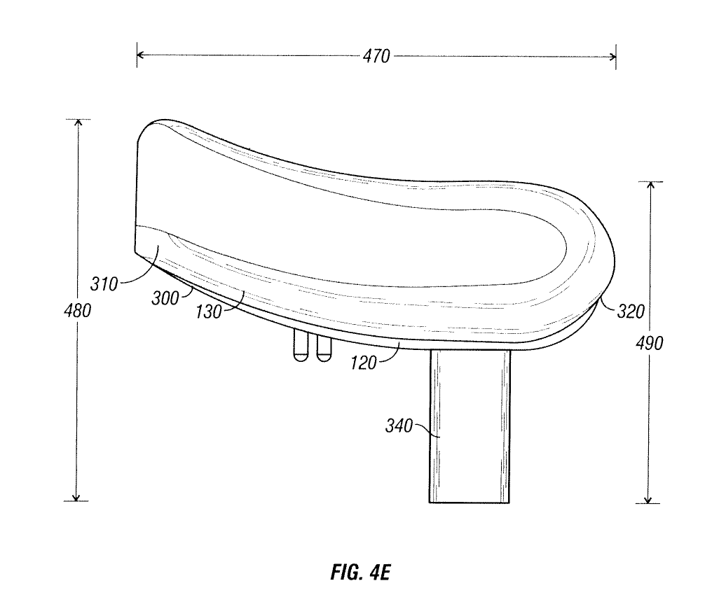

FIGS. 4A-4E provide close-ups of embodiments of mandible arm 120. Mandible arm 120 may be custom sized to fit a particular patient or it may be sized such that it fits a number of patients. For example, mandible arm 120 may be smaller for pediatric patients than for adult patients, or mandible arm 120 may be available in a variety of sizes. Mandible arm 120 may be removably or fixedly attached to support 110 or it may be integral with support 110. In some embodiments, mandible arm 120 may be disposable, but in other embodiments it may be reusable, washable, and/or sterilizable. In some embodiments the shape of mandible arm 120 is such that a patient may be engaged with a device of the present invention and have a standard oxygen mask attached over the patient's mouth and/or nose.

In the depicted embodiment, mandible arm 120 includes mandible pad 130, curved portion 300 and arm portion 340. Curved portion 300 may be made of any suitable material and may have any suitable configuration. In preferred embodiments, curved portion 300 is substantially rigid, elongate, concave and has a curvature that facilitates effective contact with a patient's jaw. In some embodiments, the shape of curved portion 300 provides shape to mandible pad 130. In some embodiments, curved portion 300 is configured such that mandible arm 120 is configured to contact a patient's jaw at one or more points. In some embodiments, curved portion 300 is configured to contact the patients jaw at two or three points. In certain embodiments, curved portion 300 is configured to facilitate contact of mandible arm 120 with the ramus of a patient's jaw, the body of the patient's jaw and the angle of a patient's jaw. In other embodiments, curved portion 300 may be non-rigid, or have non-rigid portions, and may even be substantially lacking in curvature. In certain embodiments, curved portion 300 is made of a medical grade plastic, but curved portion 300 may be made of other materials, such as various other plastics, resins, resinoids, polymers, cellulose derivatives, casein materials, glass, and metals.

Curved portion 300 is illustrated as having lower end 310 and upper end 320. In the illustrated embodiments, lower end 310 is oriented toward lower side 50 of base 10 and upper end 320 is oriented toward upper side 40 of base 10. Also depicted on curved portion 300 is tubing grip 330. Tubing grip 330 may be any structure or structures configured to grip and hold tubing that may be attached to tools or equipment used during, prior to, or after a surgical, or similar, procedure is performed. For example, tubing grip 330 may be used to grip tubing that leads to an oxygen mask placed over the mouth and nose of a patient. In FIG. 4A, tubing grip 330 is illustrated as a pair of ribs spaced apart a suitable distance to permit the ribs to grip tubing without substantially impairing the flow of gas through the tubing. In FIG. 4D, tubing grip 330 is depicted as a pair of pillars also spaced apart a suitable distance to permit the ribs to grip tubing without substantially impairing the flow of gas through the tubing. In some embodiments the distance between the ribs and/or pillars is from about 1 mm to about 5 mm. In other embodiments, the distance between the ribs and/or pillars is about 2 mm. In yet further embodiments, the distance between the ribs and/or pillars is about 2.8 mm.

Returning to FIG. 4A, arm portion 340 extends medially from curved portion 300 and is configured to engage support 110. Although depicted as approximately cylindrical, with a semicircular prism portion having a flat surface 350, arm portion 340 may have any suitable shape, size and configuration, and may be made of any suitable material. Arm portion 340 may be removably or fixedly attached to support 110 and in some embodiments arm portion 340 may be integral with support 110. Arm portion 340 also may be keyed such that it will only attach to the appropriate support 110—for example, an arm portion 340 for use with a support 110 on right side 20 of base 10 may be configured such that it will only attach to that support 110. In the illustrated embodiment, arm portion 340 has flat surface 350 and medial end 360.

With reference to FIG. 4C, mandible pad 130 is highlighted. FIG. 4C illustrates mandible arm 120, with arm portion 340, curved portion 300 and mandible pad 130. Mandible pad 130 may be made of any suitable material having any suitable size, shape, and properties. In some embodiments, mandible pad 130 is elongate, but in other embodiments it may be oval, circular, rectangular or any other suitable shape. In certain embodiments mandible pad 130 may be flexible, but in other embodiments it may be malleable, resilient, rigid or any other suitable consistency. Mandible pad 130 may be made of molded or flat foam, but in other embodiments it may be made of medical grade plastic or moldover foam, other plastics, rubber, resins, metals or any other suitable material. In further embodiments mandible pad 130 may be disposable, but in other embodiments it may be reusable, washable, and/or sterilizable. Mandible pad 130 may be removably or fixedly attached to curved portion 300. In some embodiments mandible pad 130 may be attached by glue, epoxy, cement or the like, but in other embodiments mandible pad 130 may be attached to curved portion 300 in any suitable manner. In preferred embodiments, mandible pad 130 is made of flexible foam, elongate and fixedly attached to curved portion 300 with a glue or epoxy.

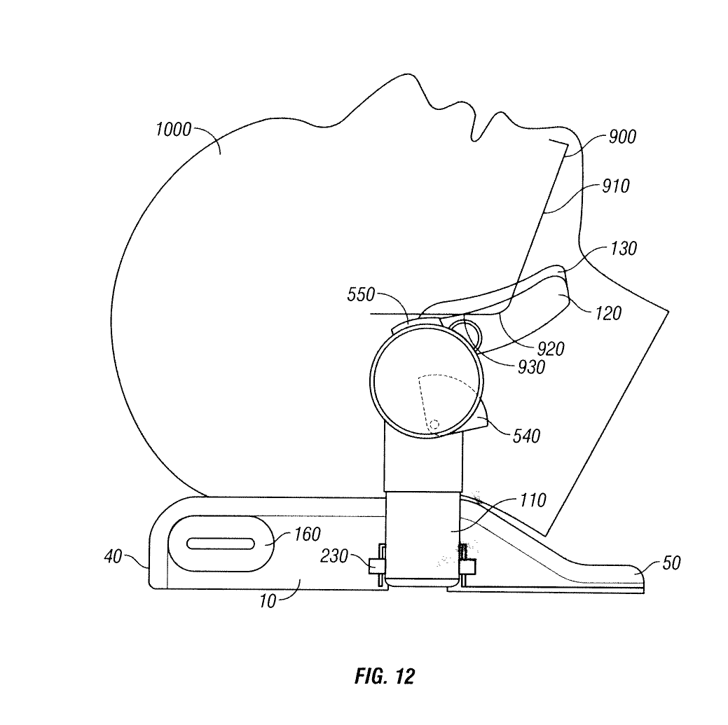

In some embodiments, mandible pad 130 is configured to contact a patient's jaw at one or more points. In some embodiments, mandible pad 130 is configured to contact the patient's jaw at two or three points. For example, with reference to FIG. 12, a patient 1000 having jaw line 900 is depicted on a device of the present invention having base 10 with upper side 40, lower side 50, support 110, and mandible arm 120 having mandible pad 130. Jaw line 900 has multiple portions corresponding to different portions of the patient's jaw bone. Ramus 930 corresponds to the edge of the ramus of the patient's jaw bone, body 910 corresponds to the edge of the body of the patient's jaw bone, and angle 920 corresponds to the edge of the angle of the patient's jaw bone. In certain embodiments, mandible pad 130 is configured to contact the ramus 930 of a patient's jaw, the body 910 of the patient's jaw and the angle 920 of a patient's jaw. Of course, references to such contact here and in other portions of this disclosure do not refer to direct contact, but rather refer to indirect contact by contact of the patient's skin.

With reference now to FIG. 4C, mandible pad 130 has distal surface 400, medial surface 410, height 420, width 460 and extends distance 430 away from curved portion 300. Height 420 may be any suitable height. For example, height 420 may be from about one tenth of an inch to about 5 inches, from about one quarter of an inch to about one and a half inches, from about one half of an inch to one inch, or any other suitable height. Similarly, distance 430 may be any suitable distance. For example, distance 430 may be from about one tenth of an inch to about five inches, from about one quarter of an inch to about one and one half inches, from about one half of an inch to one inch, or any other suitable height. Additionally, width 460 may be any suitable width. For example, width 460 may be from about one eighth of an inch to about four inches, about one half of an inch to about two and a half inches, about one inch to about two inches, or any other suitable width. The depicted embodiment has a medial surface 410 that has depression 450 having depth 440. In other embodiments, medial surface 410 may be flat, substantially flat or even convex. Although depicted as rounded, depression 450 may have any suitable shape. In addition, medial surface 410 may have multiple depressions 450 of similar, different or identical configurations. Depression 450 may be uniform or substantially uniform along the length 470 (depicted in FIG. 4E) of mandible pad 130 or its presence or characteristics may vary over the length 470 of mandible pad 130. For example depth 440 of depression 450 may be substantially constant or may vary along the length 470 of mandible pad 130. Depth 440 may be any suitable depth from the highest point of medial surface 410. For example, depth 440 may be from about one sixteenth of an inch to about one inch, from about one eighth of an inch to about three quarters of an inch, from about one quarter of an inch to about one half of an inch, or any suitable depth. Similarly, length 470 may be any suitable length. For example, length 470 may be from about one inch to about seven inches, from about two inches to about five inches, from about two and one half inches to about four inches, about three and one half inches, or any other suitable length.

With reference to FIG. 4E is a top view of an embodiment of mandible arm 120 and mandible pad 130. This FIG. depicts length 470 as described above. This FIG. also illustrates an embodiment of mandible arm 120 that, because of the curvature of curved portion 300, has a first length 480 and a second length 490. In preferred embodiments first length 480 is greater than second length 490. In some embodiments, first length 480 is from about one inch to about five inches, from about one and a half inches to about four inches, from about two and a half inches to about three and a half inches, about three inches, or any other suitable length. In some embodiments, second length 490 is from about one half inch to about five inches, from about from about one inch to about four inches, from about two and inches to about three inches, about two and a half inches, or any other suitable length. In one embodiment, first length 480 is about three inches and second length 490 is about two and one half inches.

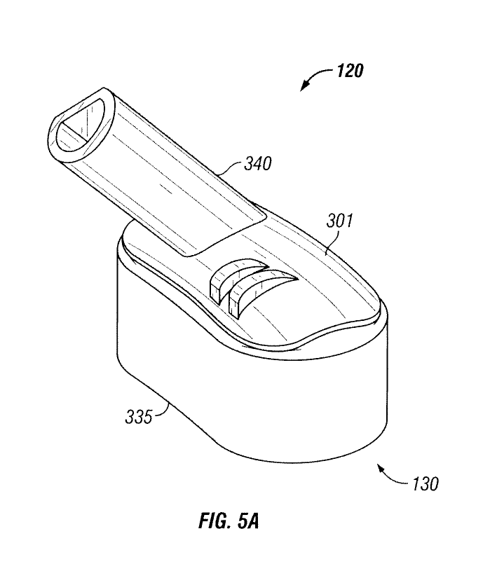

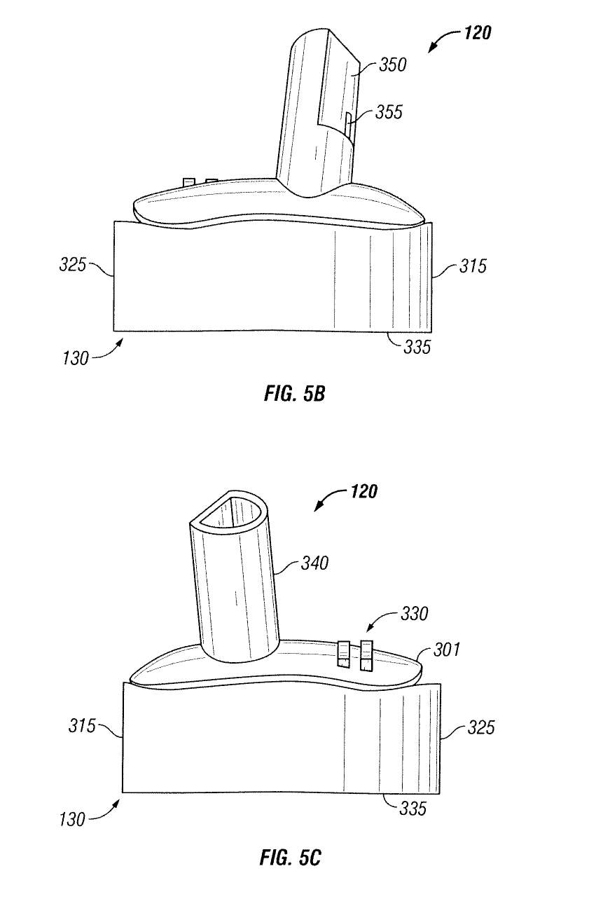

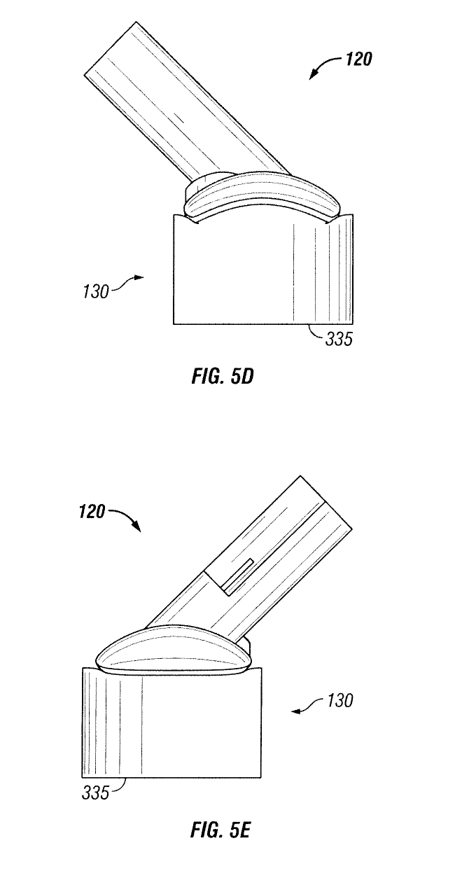

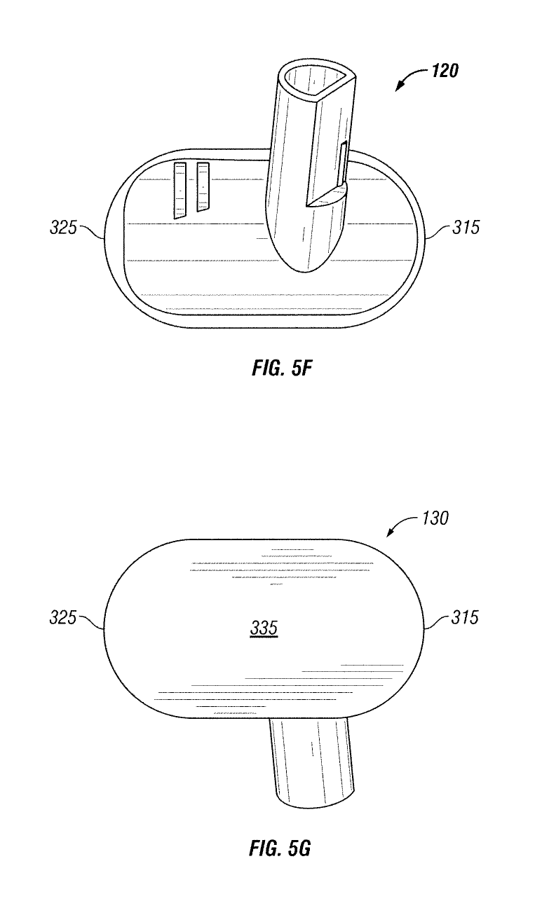

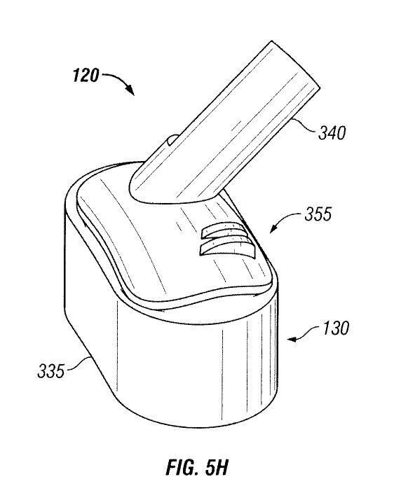

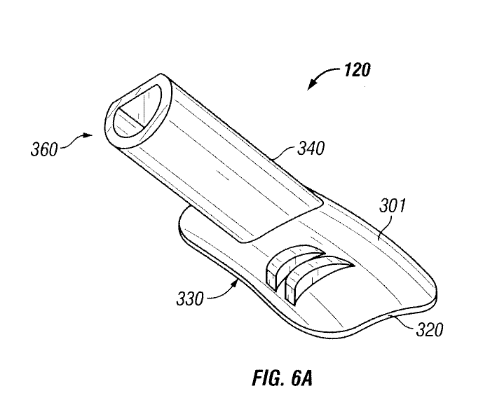

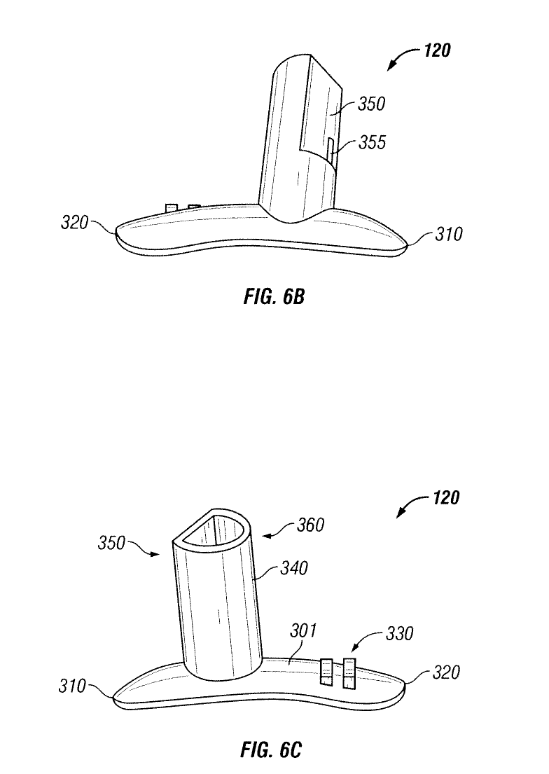

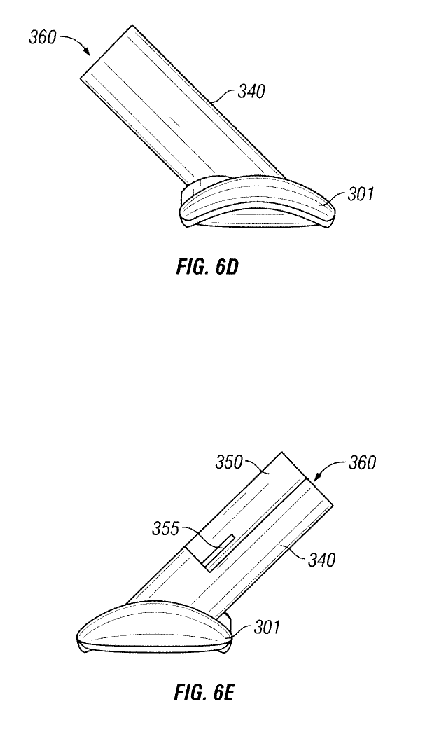

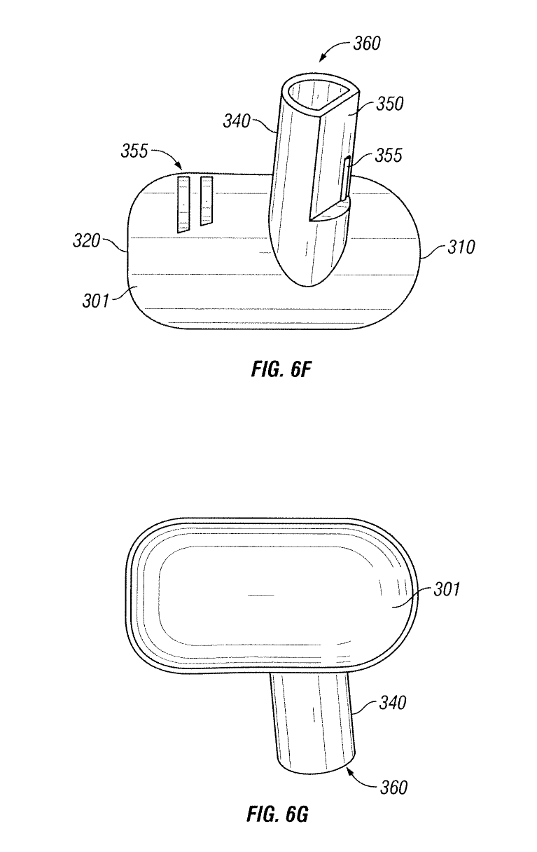

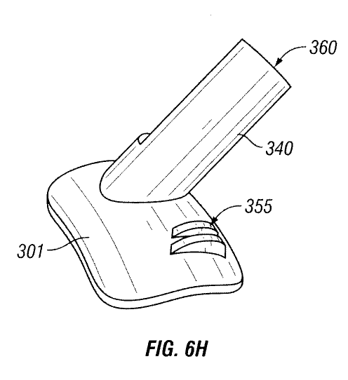

FIGS. 5A-5H provide close-ups of another embodiment of a mandible arm 120. FIGS. 5A and 5H are an auxiliary view of this embodiment of mandible arm 120; FIGS. 5B-5E illustrate side views of this embodiment of mandible arm 120; FIG. 5F depicts a bottom view of this embodiment of mandible arm 120, and FIG. 5G depicts a top view of this embodiment of mandible arm 120. FIGS. 6A-6H provide close-ups of the embodiment of a mandible arm 120 shown in FIGS. 5A-5H, but without mandible pad 130. FIGS. 6A and 614 are an auxiliary view of this embodiment of mandible arm 120; FIGS. 6B-6E illustrate side views of this embodiment of mandible arm 120; FIG. 6F depicts a bottom view of this embodiment of mandible arm 120, and FIG. 6G depicts a top view of this embodiment of mandible aim 120.

With reference now to FIGS. 5A-5H, and FIGS. 6A-6H, mandible arm 120 may be custom sized to fit a particular patient or it may be sized such that it fits a number of patients. For example, mandible arm 120 may be smaller for pediatric patients than for adult patients, or mandible arm 120 may be available in a variety of sizes. Mandible arm 120 may be removably or fixedly attached to support 110 or it may be integral with support 110. In some embodiments, mandible arm 120 may be disposable, but in other embodiments it may be reusable, washable, and/or sterilizable. In some embodiments the shape of mandible arm 120 is such that a patient may be engaged with a device of the present invention and have a standard oxygen mask attached over the patient's mouth and/or nose.

With reference to FIGS. 5A-5H, and FIGS. 6A-6H, mandible arm 120 in the depicted embodiment includes concave portion 301 and arm portion 340. In FIGS. 5A-5H, mandible arm 120 includes a mandible pad 130. Concave portion 301 may be made of any suitable material and may have any suitable configuration. In preferred embodiments, concave portion 301 is substantially rigid, elongate and concave. In some embodiments, concave portion 301 can be curved or shaped so as to provide shape to mandible pad 130. In some embodiments, concave portion 301 is configured such that mandible arm 120 is configured to contact a patient's jaw at one or more points. In some embodiments, concave portion 301 is configured to contact the patients jaw at two or three points. In certain embodiments, concave portion 301 is configured to facilitate contact of mandible arm 120 with the ramus of a patient's jaw, the body of the patient's jaw and the angle of a patient's jaw. In other embodiments, concave portion 301 may be non-rigid, or have non-rigid portions, and may even be substantially lacking in curvature as illustrated in FIGS. 5A-5H. In certain embodiments, concave portion 301 is made of a medical grade plastic, but concave portion 301 may be made of other materials, such as various other plastics, resins, resinoids, polymers, cellulose derivatives, casein materials, glass, and metals.

Concave portion 301 is illustrated as having lower end 310 and upper end 320. In the illustrated embodiments, lower end 310 is oriented toward lower side 50 of base 10 and upper end 320 is oriented toward upper side 40 of base 10. Also depicted on concave portion 301 is tubing grip 330. Tubing grip 330 may be any structure or structures configured to grip and hold tubing that may be attached to tools or equipment used during, prior to, or after a surgical, or similar, procedure is performed. For example, tubing grip 330 may be used to grip tubing that leads to an oxygen mask placed over the mouth and nose of a patient. In FIG. 5A, tubing grip 330 is illustrated as a pair of ribs spaced apart a suitable distance to permit the ribs to grip tubing without substantially impairing the flow of gas through the tubing. In other embodiments, tubing grip 330 is a pair of pillars also spaced apart a suitable distance to permit the ribs to grip tubing without substantially impairing the flow of gas through the tubing. In some embodiments the distance between the ribs and/or pillars is from about 1 mm to about 5 mm. In other embodiments, the distance between the ribs and/or pillars is about 2 mm. In yet further embodiments, the distance between the ribs and/or pillars is about 2.8 mm.

Returning to FIGS. 5A and 6A, arm portion 340 extends medially from concave portion 301 and is configured to engage support 110. Arm portion 340 is depicted as having an cylindrical portion and a semicircular prism portion extending from the cylindrical portion. Although depicted as approximately cylindrical with a semicircular prism portion having a flat surface 350, arm portion 340 may have any suitable shape, size and configuration, and may be made of any suitable material. Arm portion 340 may be removably or fixedly attached to support 110 and in some embodiments arm portion 340 may be integral with support 110.

Arm portion 340 also may be keyed such that it will only attach to the appropriate support 110—for example, an arm portion 340 for use with a support 110 on right side 20 of base 10 may be configured such that it will only attach to that support 110. For example, the size and shape of the semicircular prism can be dimensioned to provide right/left keying. As another example, in the views illustrated in FIGS. 5B, 5E, 6B, and 6E a key 355 is shown as being disposed on flat surface 350 of arm portion 340. Key 355 in the illustrated example is a single elongated ridge that extends along flat surface 350 and is configured to engage with a corresponding, complementary structure, such as a groove in support 110. The key 355 with the complementary groove in support 110 can provide a keying function such that only a right mandible arm 120 engages with a right support 110, and a left mandible arm 120 engages with a left support 110. Although key 355 is illustrated as being a single elongated ridge on flat surface 350, other structures, shapes and sizes can be used for key 355.

With reference to FIGS. 5A-5H, mandible pad 130 in this example is in the shape of a rectangular block with rounded ends 315, 325. In one embodiment, mandible pad 130 is glued or otherwise affixed to mandible arm 120. Mandible pad 130 can be glued to mandible arm 120 so as to fit into the concave portion of mandible arm 120. Accordingly, mandible pad 130 in these examples is illustrated as being compressed in places by mandible arm 120. In some applications, the process of affixing mandible pad 130 to mandible arm 120 may cause the distal surface of mandible pad 130 to take on a concave shape as well. In other embodiments, the distal surface of mandible pad 130 may remain planar or substantially planar.

Mandible pad 130 may be made of any suitable material having any suitable size, shape, and properties. In one embodiment, mandible pad is cut out from a one-inch piece of flat foam, with planar opposed surfaces. As illustrated in the example of FIGS. 5A-5H, mandible pad 130 is a rectangular cube with rounded ends. In some embodiments, mandible pad 130 is elongate, but in other embodiments it may be oval, circular, rectangular or any other suitable shape. In certain embodiments mandible pad 130 may be flexible, but in other embodiments it may be malleable, resilient, rigid or any other suitable consistency. Mandible pad 130 may be made of molded, shaped or flat foam, but in other embodiments it may be made of medical grade plastic or moldover foam, other plastics, rubber, resins, metals or any other suitable material. In further embodiments mandible pad 130 may be disposable, but in other embodiments it may be reusable, washable, and/or sterilizable. Mandible pad 130 may be removably or fixedly attached to concave portion 301. In some embodiments mandible pad 130 may be attached by glue, epoxy, cement or the like, but in other embodiments mandible pad 130 may be attached to concave portion 301 in any suitable manner. In preferred embodiments, mandible pad 130 is made of flexible foam, elongate and fixedly attached to concave portion 301 with a glue or epoxy. In some embodiments, mandible pad 130 is configured to contact a patient's jaw at one or more points. In some embodiments, mandible pad 130 is configured to contact the patient's jaw at two or three points.

With continued reference to FIGS. 5A-5H, mandible pad 130 has distal surface 455, proximal surface 415, height 425, and width 465. Height 425 may be any suitable height. For example, height 425 may be from about one tenth of an inch to about 5 inches, from about one quarter of an inch to about one and a half inches, from about one half of an inch to one inch, or any other suitable height. Similarly, width 465 may be any suitable width. For example, width 465 may be from about one eighth of an inch to about four inches, about one half of an inch to about two and a half inches, about one inch to about two inches, or any other suitable width. The depicted embodiment has a proximal surface 415 that is flat. In other embodiments, proximal surface 415 may be concave, substantially flat or even convex. In addition, proximal surface 415 may have multiple depressions (not shown) of similar, different or identical configurations. Such depressions may be uniform or substantially uniform along the length 475 of mandible pad 130 or its presence or characteristics may vary over the length 475 of mandible pad 130. For example the depth of a depression may be substantially constant or may vary along the length 475 of mandible pad 130. Also, the depth may be any suitable depth from the highest point of the medial surface. For example, the depth may be from about one sixteenth of an inch to about one inch, from about one eighth of an inch to about three quarters of an inch, from about one quarter of an inch to about one half of an inch, or any suitable depth. Similarly, length 475 may be any suitable length. For example, length 475 may be from about one inch to about seven inches, from about two inches to about five inches, from about two and one half inches to about four inches, about three and one half inches, or any other suitable length. As illustrated in FIGS. 5A-5H, mandible pad 130 is also flat on the distal surface 415, but it can have other shapes or contours. For example, distal surface 455 can be domed to conform to the concave portion of mandible arm 120.

In addition to or in place of the keying structures described herein, embodiments of mandible arm 120 can be color coded, as can right and left supports 110 to facilitate right-left placement of the mandible arms 120 into supports 110. For example, the right mandible arm 120 and right support 110 can be color coded green, and the left mandible arm 120 and left support 110 can be color coded red, although other color codes and combinations can be utilized.

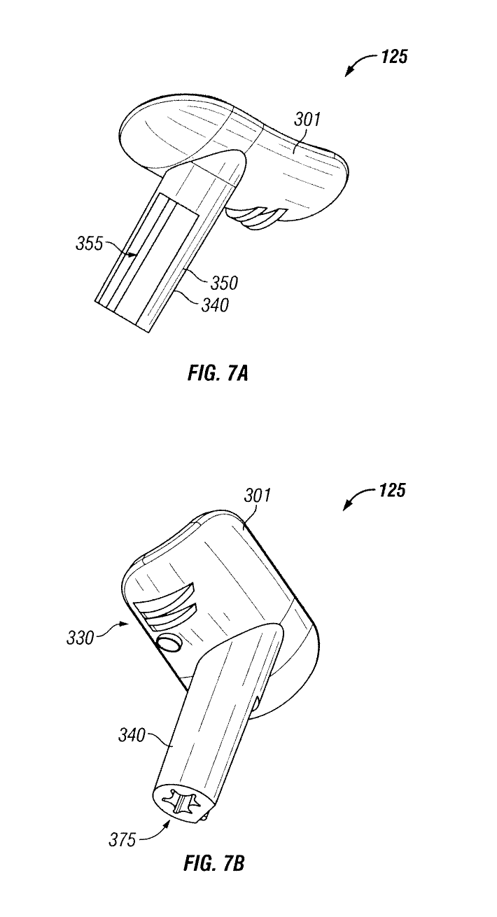

FIGS. 7A and 7B are diagrams illustrating yet another embodiment for a mandible arm. As shown in FIG. 7A, key 355 in this embodiment extends the length of flat surface 352 the medial end 360 of arm portion 340. As shown in FIG. 7B, a cavity 375 in medial end 360 of arm portion 340 is of an irregular shape. As will be appreciated by one of ordinary skill in the art after reading this description cavity 375 can take on any of a number of different shapes and can be configured to mate with a complementary shape on support 110.

FIGS. 8A-8C are close-ups of embodiments of support 110. In the illustrated embodiment, support 110 has a first portion 500, a second portion 510 and a third portion 560 that may be removably or fixedly attached to each other and/or base 10. In other embodiments support 110 may be a unitary structure and/or may be integral with base 10 and/or mandible arm 120. Although depicted as having various parts having specific shapes and connections, support 110 may have any suitable configuration and have any suitable shape.

In preferred embodiments, support 110 is adjustable in at least one axis. In some embodiments support 110 is adjustable in an x-axis (for example, as defined by insertion portion 200 and mandible gap 150 (see FIG. 1) and/or a y-axis (for example, as defined by height 620 of upper portion 610). In other embodiments support 110 may also be adjustable in a z-axis (for example and with reference to FIG. 1, as defined by the edge of right side 20 of base 10) and/or a w-axis (for example, defined as by rotation of third portion 560). In preferred embodiments, support 110 is adjustable in at least the x, y and w axes.

In some embodiments, the adjustment of support 110 places mandible arm 120 in contact with a patient's jaw at two or three points. In some embodiments, adjustment of support 110 results in placing and/or holding the patient in a desired position. In some embodiments, the desired position is the sniffing position. For example, with reference to FIG. 8, a patient 1000 having jaw line 900 is depicted on a device of the present invention having base 10 with upper side 40, lower side 50, support 110, and mandible arm 120 having mandible pad 130. Jaw line 900 has multiple portions corresponding to different portions of the patient's jaw bone. In certain embodiments, support 110 is adjustable such that mandible arm 120 may be moved to contact the ramus 930 of a patient's jaw, the body 910 of the patient's jaw and the angle 920 of a patient's jaw.

With reference to FIG. 8A, an embodiment of first portion 500 of support 110 is depicted. First portion 500 has length 600, a first height 590, a second height 620, connector 220, button 230, insertion portion 200 and upper portion 610. Connector 220, button 230 and insertion portion 200 were described with reference to FIGS. 3A-3B. As illustrated, insertion portion 200 has length 600, width 580 and height 590, each of which may be any suitable magnitude. For example, length 600 may be from about one inch to about eight inches, from about two inches to about five inches, from about two and a half inches to about four inches, from about three to about three and a half inches, or any suitable length. For example, width 580 may be from about one half of one inch to about six inches, from about one inch to about three inches, from about one and a half inches and about two and a half inches, or any suitable width. For example, height 590 may be from about one eighth of an inch to about three inches, from about one quarter of an inch to about one and a half inches, from about a half an inch to about an inch, or any suitable thickness.

Similarly, upper portion 610 may have a length 620 that is similar or different than that of insertion portion 200. For example, length 600 may be from about one inch to about eight inches, from about two inches to about five inches, from about two and a half inches to about four inches, from about three to about three and a half inches, or any suitable length. The other dimensions of upper portion 610 may be of dimensions similar to those described with respect to insertion portion 200. Upper portion 610 may also have a connection element that facilitates or accomplishes connection between first portion 500 and second portion 510 of support 110.

Continuing with reference to FIG. 8A, an embodiment of second portion 510 is illustrated. Second portion 510 has height 630, width 640 and thickness 690, each of which may be any suitable magnitude. For example, height 630 may be from about one inch to about eight inches, from about two inches to about five inches, from about two and a half inches to about four inches, from about three to about three and a half inches, or any suitable height. For example, width 640 may be from about one half of one inch to about six inches, from about one inch to about three inches, from about one and a half inches and about two and a half inches, or any suitable width. For example, thickness 690 may be from about one eighth of an inch to about three inches, from about one quarter of an inch to about one and a half inches, from about a half an inch to about an inch, or any suitable thickness. In some embodiments thickness 690 and width 640 are greater than the corresponding dimensions of upper portion 610 of first portion 500 such that at least part of first portion 500 fits within second portion 510. Preferably, the dimensions are sufficiently greater such that the overall height of support 110 is adjustable by movement of second portion 510 along the y-axis over upper portion 610 of first portion 500 of support 110. In other embodiments, the dimensions of first portion 500 may be greater than those of second portion 510 such that at least a part of second portion 510 fits within first portion 500.

Second portion 510 also has first portion connector 700 and third portion connector 520. First portion connector 700 may be any suitable structure that facilitates connection between second portion 510 and first portion 500 of support 110. Preferably, first portion connector 700 interacts with an element on first portion 500 such that second portion 510 may be selectively moved relative to first portion 500. In some embodiments, first portion connector 700 is selectively engaged/disengaged with an element of first portion 500 by height adjustment button 540 (see FIG. 8B). In such embodiments, depressing height adjustment button 540 disengages first portion connector 700 and permits movement of second portion 510 relative to first portion 500 along the y-axis. Releasing height adjustment button 540 would then engage first portion connector 700 such that second portion 510 would be locked into place along the y-axis. In some embodiments, first portion connector 700 interacts with height adjuster 720 in third portion 560 (see FIG. 8B). In such an embodiment depressing height adjustment button 540 causes height adjuster 720 to interact with first portion connector 700 such that it disengages from the element in first portion 500, thereby permitting movement of second portion 510 along the y-axis relative to first portion 500.

Second portion 510 also has third portion connector 520. Third portion connector 520 may be any suitable structure that facilitates connection between second portion 510 and third portion 560. In the depicted embodiment, third portion connector is a cylindrical extension form second portion 510 that fits within orifice 680 (see FIG. 8B) of third portion 570. Third portion connector 520 and orifice 680 may have any suitable size and characteristics.

With reference now to FIGS. 8B and 8C, preferably, second portion connector 520 interacts with rotation adjuster 710 on third portion 560 such that third portion 560 may be selectively moved relative to second portion 510. In some embodiments, third portion connector 520 is selectively engaged/disengaged with rotation adjuster 710 by rotation adjustment button 550 (see FIG. 7B). In such embodiments, depressing rotation adjustment button 550 disengages third portion connector 520 from rotation adjuster 710 and permits movement of third portion 560 relative to second portion 510 along the w-axis. Releasing rotation adjustment button 550 would then engage second portion connector 520 from rotation adjuster 710 such that third portion 560 would be locked into place along the w-axis.

With reference again to FIGS. 8B and 8C, an embodiment of third portion 560 is illustrated. Third portion 560 has rotation adjustment button 550, height adjustment button 540, mandible arm receiver 530, main portion 570, orifice 680, rotation adjuster 710 and height adjuster 720. Although depicted as buttons, rotation adjustment button 550 and height adjustment button 540 may be any suitable structure that may be manipulated by a person. In addition, rotation adjustment button 550 and height adjustment button 540 may be placed on any suitable location on support 110 (even on each of the different portions described herein) or on other parts of the device. Preferably, rotation adjustment button 550 and height adjustment button 540 are positioned such that a person could place his/her hand on support 110 and interact with both.

Third portion 560 may have any suitable configuration and be any suitable shape. Thus, although in the illustrated embodiment third portion 560 is substantially circular, it may be any suitable shape. In preferred embodiments, third portion 560 rotates in a w-axis, such that mandible arm 120 moves in a w-axis. In some embodiments this movement aids positioning of mandible arm 120 with respect to a patient and, more specifically, the patient's jaw bone. Preferably, third portion 560 is configured such that it may be grasped and manipulated by a human hand. Thus, preferably a person could grasp third portion 560 such that the person could interact with rotation adjustment button 550 and height adjustment button 540 in a manner that would permit the person to adjust support 110, thereby adjusting/positioning mandible arm 120. By so doing, a person could then cause mandible arm 120 to contact a patient such that the patient may be placed and/or held in a desired position, for example the sniffing position.

Main portion 560 is depicted as circular, but it may be any suitable shape. Main portion 560 has height 650 and width 670, which may be equal or different and may have any suitable magnitude. For example, height 650 may be may be from one inch to about eight inches, from about two inches to about five inches, from about two and a half inches to about four inches, from about three to about three and a half inches about one half of one inch to about six inches, from about one inch to about three inches, from about one and a half inches and about two and a half inches, or any suitable height. For example, width 670 may be from one inch to about eight inches, from about two inches to about five inches, from about two and a half inches to about four inches, from about three to about three and a half inches about one half of one inch to about six inches, from about one inch to about three inches, from about one and a half inches and about two and a half inches, or any suitable length.

With reference again to FIGS. 8B and 8C, third portion 560 also has mandible arm receiver 530. Mandible arm receiver interacts with arm portion 340 of mandible arm 120 (see FIGS. 4A-4E, 5A-5H, and 6A-6H). Mandible arm receiver 530 may have any suitable length. For example, mandible arm receiver 530 may be from about one eighth of an inch to about three inches, from about one quarter of an inch to about one and a half inches, from about a half an inch to about an inch, or any suitable thickness. Mandible arm receiver 530 may also have any suitable configuration and/or shape. Thus, although in the depicted embodiment mandible arm receiver 530 may be substantially cylindrical, it may be any suitable structure. In the depicted embodiment medial end 360 (for example, see FIG. 4A) is inserted into mandible arm receiver 530 and mandible aim receiver 530 holds mandible arm 120 in place via its connection with arm portion 340. Arm portion 340 may be removably, adjustably or fixedly attached to mandible arm receiver 530 and arm portion 340 may be integral with mandible aim receiver 530. Mandible arm receiver 530 may also have a release button 370. Release button 370 directly or indirectly interacts with arm portion 340 to permit insertion and/or removal of arm portion 340 into and/or from mandible arm receiver 530. Release button 370 may also permit adjustment of the extent of insertion of arm portion 340 into mandible arm receiver 530, such that the distance between mandible arm 120 and third portion 560 may be increased or decreased. Such movement would also permit adjustment of mandible gap 150 (see FIG. 1). Release button 370 may be any suitable structure, including a button, latch, switch or dial. Release button 370 may also be placed on any suitable location on the device.

In some embodiments arm portion 340 has flat portion 350 that interacts with a surface within mandible arm receiver 530. In some embodiments, this interaction prevents one from inserting the left mandible arm 120 into the right support 110, and vice-versa.

With reference now to FIG. 8C, in certain embodiments, mandible arm 120 may be connected to third portion 560 in a manner that permits movement of mandible arm 120 relative to support 110. For example, mandible arm 120 may be movable in one or more axes, including the x, y and z axes relative to support 110. In such embodiments the movement of mandible arm 120 may facilitate placing and/or maintaining a patient in a desired position, including the sniffing position.

FIGS. 9A-9C are close-ups of another embodiment of support 110. In the illustrated embodiment, this example of support 110 has a first portion 1100, a second portion 1110 and a third portion 1160 that may be removably or fixedly attached to each other and/or base 10. In other embodiments support 110 may be a unitary structure and/or may be integral with base 10 and/or mandible arm 120. Although depicted as having various parts having specific shapes and connections, support 110 may have any suitable configuration and have any suitable shape.

In preferred embodiments, support 110 is adjustable in at least one axis. In some embodiments support 110 is adjustable in an x-axis (for example, as defined by insertion portion 1222 and mandible gap 150 (see FIG. 1) and/or a y-axis (for example, as defined by height 1220 of upper portion 1210). In other embodiments support 110 may also be adjustable in a z-axis (for example and with reference to FIG. 1, as defined by the edge of right side 20 of base 10) and/or a w-axis (for example, defined as by rotation of third portion 1160). In preferred embodiments, support 110 is adjustable in at least the x, y and w axes.

In some embodiments, the adjustment of support 110 places mandible arm 120 in contact with a patient's jaw at two or three points. In some embodiments, adjustment of support 110 results in placing and/or holding the patient in a desired position. In some embodiments, the desired position is the sniffing position.

With reference to FIG. 9A, an embodiment of first portion 1100 of support 110 is depicted. First portion 1100 has length 1200, a first height 1190, a second height 1220, connector (not shown), button 1233, insertion portion 1222 and upper portion 1210. Connector, button 1233 and insertion portion 1222 were described with reference to FIGS. 3A-3B. As illustrated, insertion portion 1222 has length 1200, width 1180 and height 1190, each of which may be any suitable magnitude. For example, length 1200 may be from about one inch to about eight inches, from about two inches to about five inches, from about two and a half inches to about four inches, from about three to about three and a half inches, or any suitable length. For example, width 1180 may be from about one half of one inch to about six inches, from about one inch to about three inches, from about one and a half inches and about two and a half inches, or any suitable width. For example, height 1190 may be from about one eighth of an inch to about three inches, from about one quarter of an inch to about one and a half inches, from about a half an inch to about an inch, or any suitable thickness.

Similarly, upper portion 1210 may have a length 1220 that is similar or different than that of insertion portion 1222. For example, length 1200 may be from about one inch to about eight inches, from about two inches to about five inches, from about two and a half inches to about four inches, from about three to about three and a half inches, or any suitable length. The other dimensions of upper portion 1210 may be of dimensions similar to those described with respect to insertion portion 1222. Upper portion 1210 may also have a connection element that facilitates or accomplishes connection between first portion 1100 and second portion 1110 of support 110.

Continuing with reference to FIGS. 9B-9C, an embodiment of second portion 1110 is illustrated. Second portion 1110 has height 1230, width 1240 and thickness 1290, each of which may be any suitable magnitude. For example, height 1230 may be from about one inch to about eight inches, from about two inches to about five inches, from about two and a half inches to about four inches, from about three to about three and a half inches, or any suitable height. For example, width 1240 may be from about one half of one inch to about six inches, from about one inch to about three inches, from about one and a half inches and about two and a half inches, or any suitable width. For example, thickness 1290 may be from about one eighth of an inch to about three inches, from about one quarter of an inch to about one and a half inches, from about a half an inch to about an inch, or any suitable thickness. In some embodiments thickness 1290 and width 1240 are greater than the corresponding dimensions of upper portion 1210 of first portion 1100 such that at least part of first portion 1100 fits within second portion 1110. Preferably, the dimensions are sufficiently greater such that the overall height of support 110 is adjustable by movement of second portion 1110 along the y-axis over upper portion 1210 of first portion 1100 of support 110. In other embodiments, the dimensions of first portion 1100 may be greater than those of second portion 1110 such that at least a part of second portion 1110 fits within first portion 1100.

Second portion 1110 also has first portion connector 1300. First portion connector 1300 may be any suitable structure that facilitates connection between second portion 1110 and first portion 1100 of support 110. Preferably, first portion connector 1300 interacts with an element on first portion 1100 such that second portion 1110 may be selectively moved relative to first portion 1100. In some embodiments, first portion connector 1300 is selectively engaged/disengaged with an element of first portion 1100 by adjustment button 1140. In such embodiments, depressing adjustment button 1140 disengages first portion connector 1300 and permits movement of second portion 1110 relative to first portion 1100 along the y-axis. Releasing adjustment button 1140 would then engage first portion connector 1300 such that second portion 1110 would be locked into place along the y-axis. In some embodiments, first portion connector 1300 interacts with height ratchet pawls 1334 in second portion 1110 (see FIG. 9C). In such an embodiment depressing adjustment button 1140 causes height ratchet pawls 1334 to interact with first portion connector 1300 such that it disengages from the element in first portion 1100, thereby permitting movement of second portion 1110 along the y-axis relative to first portion 1100.

With reference again to FIGS. 9B and 9C, an embodiment of second portion 1110 third portion 1160 is illustrated. Third portion 1160 has adjustment button 1140, and mandible arm receiver 1130. Although depicted as a button, adjustment button 1140 may be any suitable structure that may be manipulated by a person. In addition, adjustment button 1140 may be placed on any suitable location on support 110 (even on each of the different portions described herein) or on other parts of the device. Preferably, adjustment button 1140 is positioned such that a person could place his/her hand on support 110 and interact with both. In one embodiment, adjustment button 1140 is configured to help our user to adjust the height of second portion 1110 along the vertical axis of first portion 1100. Additionally, in one embodiment, adjustment button 1140 can be used to adjust the azimuthal position of third portion 1160 about an axis (for example, a w-axis as described below).

Third portion 1160 may have any suitable configuration and be any suitable shape. Thus, although in the illustrated embodiment third portion 1160 is substantially circular, it may be any suitable shape. In preferred embodiments, third portion 1160 rotates in a w-axis, such that mandible arm 120 moves in a w-axis. In some embodiments this movement aids positioning of mandible arm 120 with respect to a patient and, more specifically, the patient's jaw bone. Preferably, third portion 1160 is configured such that it may be grasped and manipulated by a human hand. Thus, preferably a person could grasp third portion 1160 such that the person could interact with adjustment button 1140 in a manner that would permit the person to adjust support 110, thereby adjusting/positioning mandible arm 120. By so doing, a person could then cause mandible arm 120 to contact a patient such that the patient may be placed and/or held in a desired position, for example the sniffing position.

Third portion 1160 has height 1250 and width 1270, which may be equal or different and may have any suitable magnitude. For example, height 1250 may be may be from one inch to about eight inches, from about two inches to about five inches, from about two and a half inches to about four inches, from about three to about three and a half inches about one half of one inch to about six inches, from about one inch to about three inches, from about one and a half inches and about two and a half inches, or any suitable height. For example, width 1270 may be from one inch to about eight inches, from about two inches to about five inches, from about two and a half inches to about four inches, from about three to about three and a half inches about one half of one inch to about six inches, from about one inch to about three inches, from about one and a half inches and about two and a half inches, or any suitable length.

With reference again to FIGS. 9B and 9C, third portion 1160 also has mandible arm receiver 1130. Mandible arm receiver interacts with arm portion 340 of mandible arm 120, or 125 (see FIGS. 4A-4E, 5A-5H, and 6A-6H). Mandible arm receiver 1130 may have any suitable length. For example, mandible arm receiver 1130 may be from about one eighth of an inch to about three inches, from about one quarter of an inch to about one and a half inches, from about a half an inch to about an inch, or any suitable thickness. Mandible arm receiver 1130 may also have any suitable configuration and/or shape. Thus, although in the depicted embodiment mandible arm receiver 1130 may be substantially cylindrical, it may be any suitable structure.

In one embodiment, mandible arm receiver 1130 includes an opening 1135 which forms a receptor structure to receive mandible arm 120. Preferably, opening 1135 is shaped such that it is a complementary shape to mandible arm 120. In the illustrated embodiment, opening 1135 includes an arcuate portion and a flat portion so as to accept a mandible arm such as mandible arms 120 and 125 having a flat surface 350 on arm portion 340 as illustrated in FIGS. 4A and 5A. This opening configured to accept a semicircular prism shape can provide a keying function. Furthermore, opening 1135 can include a complementary key structure 1137 to mate with key structure 355 on the flat surface 350 of arm portion 340. The key structures 1137, 355 can be used to ensure that a right mandible cup 120 is inserted in the right support 110 and that a left to mandible cup 120 is inserted in left support 110. In the illustrated embodiment, key structure 1137 is a longitudinal groove configured to accept the complementary elongated ridge that forms key structure 355 as illustrated in FIGS. 5B and 7A. Additionally, in other embodiments, a part of or all of mandible cups 120 and supports 110 can be color-coded to provide a visual cue for right and left placement of the mandible cups 120. In one embodiment, only the end surface of medial end 360 is color-coded, however in other embodiments other portions of the mandible cups 120, or the entirety of mandible cups 120 can be color-coded.

In the depicted embodiment, medial end 360 (for example, see FIGS. 4A and 5A) is inserted into mandible arm receiver 1130 and mandible arm receiver 1130 holds mandible arm 120, 125 in place via its connection with arm portion 340. Arm portion 340 may be removably, adjustably or fixedly attached to mandible arm receiver 1130 and arm portion 340 may be integral with mandible arm receiver 1130. Mandible arm receiver 1130 may also have a release button (not shown). The release button can directly or indirectly interact with arm portion 340 to permit insertion and/or removal of arm portion 340 into and/or from mandible arm receiver 1130. The release button may also permit adjustment of the extent of insertion of arm portion 340 into mandible arm receiver 1130, such that the distance between mandible arm 120 and third portion 1160 may be increased or decreased. Such movement would also permit adjustment of mandible gap 150 (see FIG. 1). The release button may be any suitable structure, including a button, latch, switch or dial, and may also be placed on any suitable location on the device.

In some embodiments arm portion 340 has flat portion 350 that interacts with a surface within mandible arm receiver 1130. In some embodiments, this interaction prevents one from inserting the left mandible arm 120 into the right support 110, and vice-versa. Keying 355 can further ensure proper right/left placement.

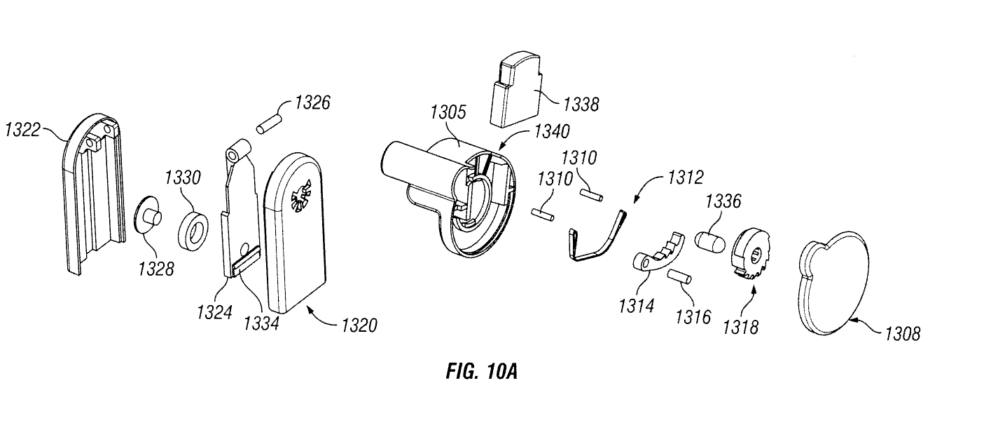

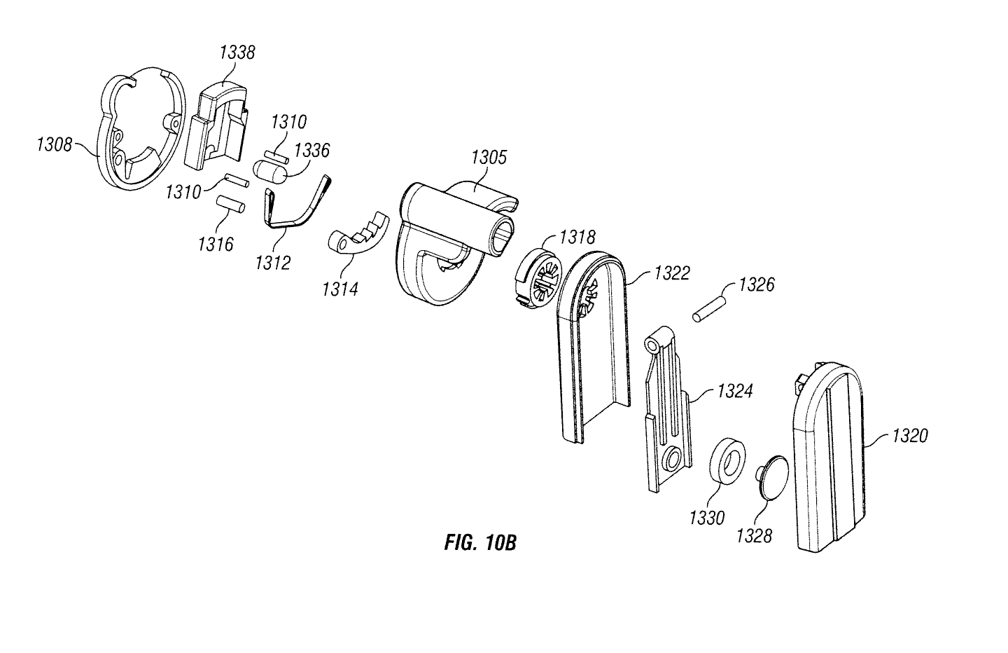

FIG. 10A is diagram illustrating a blow-up view of a right side second portion 1110 and third portion 1160 in accordance with one embodiment of the invention. As illustrated in this example, the body of third portion 1160 includes a pivot housing 1305 and a pivot cap 1308 in which the components for allowing the third portion 1162 to pivot are housed. Second portion 1110 includes two body halves 1320, 1322 that can be glued or otherwise fastened together to form the structure of second portion 1110 as well as to house a vertical ratchet pawl 1324. Vertical ratchet pawl 1324 is used to engage a first portion 1100 to allow the height to be adjusted and locked into place. In this embodiment, a first portion 1100 (FIG. 9A) can be inserted into second portion 1110. Vertical ratchet pawl 1324 is attached to ratchet support half 1322 via a vertical ratchet pin 1326. A ratchet piston 1328 is inserted through a donut-shaped foam spring 1330 and a mating hole 1332 on vertical ratchet pawl 1324. Foam spring 1330 allows vertical ratchet pawl 1332 to pivot about vertical ratchet pin 1326. This allows ratchet teeth 1334 to selectively engage and disengage with corresponding ratchet teeth (not illustrated) on first portion 1100 (FIG. 9A).

O-ring pins 1310 are disposed within pivot housing 1305 and are used to anchor belt 1312 that provides elastic tension on a pivot ratchet pawl 1314. A pivot ratchet pin 1360 is also disposed in housing 1305. Pivot ratchet pawl 1314 is pivotally mounted on pivot ratchet pin 1360 to allow third portion 1160 to be pivoted or rotated in a ratcheting type fashion. The ends of belt 1312, which can be made of rubber or other elastic or elastomeric material, are positioned over pins 1310 and stretched under pivot ratchet pawl 1314.

Pivot index 1318 is mounted inside pivot housing 1305 and has teeth configured to engage teeth of pivot ratchet pawl 1314. Preferably, pivot index 1318 is fixedly mounted to ratchet support 1320 and disposed within pivot housing 1305 such that it can rotate freely with respect to pivot housing 1305. Vertical ratchet pin 1336 is inserted through a central hole in pivot index 1318.

A pivot button 1338, which in this example forms button 1140 of FIGS. 9B and 9C, is positioned in a recess 1340 in pivot housing 1305. Pivot button 1338 engages with belt 1312 and when depressed, stretches belt 1312 such that pivot ratchet pawl 1314 disengages from pivot index 1318, allowing the pivot housing 1160 to rotate about its axis.

Depressing pivot button 1338 also causes vertical ratchet pawl 1332 to pivot about vertical ratchet pin 1326, compressing foam spring 1330. For example, this can be caused by pushing vertical ratchet pin 1336 against vertical ratchet pawl 1324. This action allows ratchet teeth 1334 to disengage with corresponding ratchet teeth (not illustrated) on the inside of body half 1320, allowing vertical movement. When button 1338 is released, foam spring 1330 causes ratchet teeth 1334 to re-engage with the complementary teeth on the inside of body half 1320, releasably locking into place at the selected vertical height of the unit.

FIG. 10B is diagram illustrating a blow-up view of a left side second portion 1110 and third portion 1160 in accordance with one embodiment of the invention. The components and their assembly are similar to that described above in FIG. 10 A. for the left hand side. However, FIG. 10 B. illustrates these components from an inside view perspective.

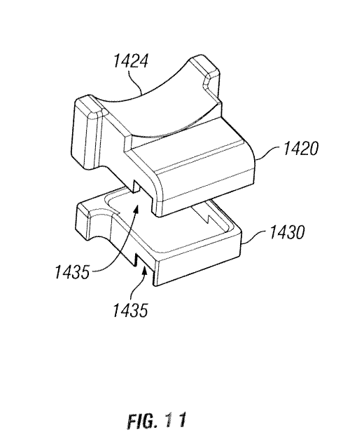

FIG. 11 is a diagram illustrating another embodiment of a base that can be used to support a patient's head. In this embodiment, a headpiece 1420 includes a flat portion 1422 and a concave portion 1424. Concave portion 1424 is designed to support a patient's head and to reduce or eliminate side to side turning of the patient's head during use of the device. In some embodiments, headpiece 1420 may be made of medical grade plastic or closed-cell foam. Headpiece 1420 may also be made of various other MRI compatible materials, including plastics, resins, resinoids, polymers, cellulose derivatives, casein materials, and metals. Headpiece 1420 may also include a cover on all or a portion of headpiece 1420. For example, such cover may be made of soft or hard foam, fabric, or cushioned material. Such materials may also be integral with a portion of headpiece 1420.

In the illustrated example, headpiece 1420 is a hollow structure and configured to be positioned over headpiece support 1430. Both headpiece 1420 and headpiece support 1430 include recesses 1435 to accommodate supports 110. Headpiece support 1430 can be made of plastics, metals or other materials such as medical grade plastic, resins, resinoids, polymers, cellulose derivatives, casein materials, and glass.

In one embodiment, headpiece 1420 is a flexible foam or foam-like material and headpiece support provides structural rigidity to headpiece 1420. In such a configuration, headpiece 1420 can be configured as a disposable device they can be used one or more times and discarded after use. Preferably, in such embodiments, headpiece 1420 is made of low-cost material to reduce the expense associated with one-use disposable items. Accordingly, structural support for headpiece 1420 is provided by headpiece support 1430 which can provide necessary structural rigidity to the assembly. Accordingly, in one embodiment, headpiece support 1430 is reusable and can be used many times with replacement headpieces 1420.

In addition to the various devices described herein, the present invention also includes methods. Generally, the methods of the present invention relate to placing and/or maintaining a patient in a desired position. In some embodiments, this is a position that facilitates regular or semi-regular breathing by a patient that is under sedation or general anesthesia. For example, the desired position may be the sniffing position. The methods may include the use of various equipment, such as an 0₂ or face mask with associated tubing in order to provide mask ventilation, various other breathing apparatuses, including tubes at least partially inserted into the patient. Various embodiments of the methods include the use of the devices described herein. For example, a patient may be placed in a desired position, and then a device of the present invention may be adjusted to maintain the patient in a desired position. In other embodiments, a device of the present invention may be used to place the patient in a desired position. In further embodiments, a device of the present invention may be used to place and maintain a patient in a desired position. In some embodiments, the methods provide a quick and easy method of positioning a patient with a single interaction with a device. In some embodiments, the methods permit one to position the patient in a single movement or in a single contact with a device of the present invention.

By way of example, and with reference to FIG. 12, a device according to the present invention may be appropriately positioned using, or not using, gripping element 160 to manipulate and position base 10 on a gurney, operating table, dentists' chair or any other suitable place. A patient 1000 could be placed on a device of the present invention having base 10 such that the top of the patient's head is oriented with upper side 40 of base 10 and the patient's neck would be oriented with lower side 50 of base 10. Such placement could be done before or after positioning of base 10. The patient could be appropriately placed on base 10 with or without reference to an alignment guide 155 (see FIG. 1). For example, a patient 1000 may be positioned such that the patient's mouth is approximately in line with supports 110 (and/or alignment guide 155). Once positioned (or in some embodiments, as the patient 1000 is positioned), mandible gap 150 (see FIG. 1) may be adjusted by moving support 110 along the x-axis, thereby increasing support width 140. In some embodiments, this may be done by pressing button 230 on support 110 and moving support toward or away from base 10 until support 110 is in a desired position and then releasing button 230 to lock support 110 in place. In addition, support 110 may also be adjusted in the y-axis. In some embodiments, this may be done by depressing height adjustment button 540 and moving support 110 in the y-axis until support 110 is in a desired position and then releasing height adjustment button 540. Moreover and as necessary, support 110 may also be adjusted in the w-axis or the z-axis. In some embodiments, this may be done by depressing rotation adjustment button 550 and moving support 110 in the w-axis until support 110 is in a desired position and then releasing rotation adjustment button 550. In further embodiments such as illustrated in FIGS. 9A-9C, the height adjustment and adjustments in the w-axis or the z-axis can be made using button 11140. These adjustments may be repeated for the support 110 on the other side of base 10. In some embodiments support 110 is positioned relative to patient 1000 such that rotational movement of support 110 (and mandible a in 120) in the w-axis may tilt the patient's head back such that the patient's airway is opened. As these drawings illustrate, the device, in some embodiments, can be configured such that the mandible pads and the base can be configured to provide support for a patient for one or more of flexion of the cervical spine, extension of the head, and anterior displacement of the mandible.

The various adjustments (done only as necessary) may be done until mandible arm 120 contacts the patient in such a way that the patient is placed and/or maintained in a desired position. For example, adjustment(s) may be made until mandible pad 130 contacts one or more points of the patient's jaw. In some embodiments, the adjustment(s) will be made until the mandible pad 130 contacts the ramus 930 of a patient's jaw, the body 910 of the patient's jaw and the angle 920 of a patient's jaw. As these drawings illustrate, these adjustments, in some embodiments, can be performed such that the mandible pads and the base can be configured to provide support for a patient for one or more of flexion of the cervical spine, extension of the head, and anterior displacement of the mandible.

Thus, it is seen that devices and methods are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various FIGS. may depict an example configuration for the invention, which is done to aid in understanding the features and functionality that may be included in the invention. The invention is not restricted to the illustrated example configurations, but the desired features may be implemented using a variety of alternative configurations. Indeed, it will be apparent to one of skill in the art how alternative functional, logical or physical configurations may be implemented to implement the desired features of the present invention. Also, a multitude of different constituent part names other than those depicted herein may be applied to the various parts or elements. Additionally, with regard to method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams and other illustrations. As will become apparent to one of ordinary skill in the art after reading this document, the illustrated embodiments and their various alternatives may be implemented without confinement to the illustrated examples. For example, the FIGS. and their accompanying description should not be construed as mandating a particular configuration, including a particular geometry of the various parts and elements.

What is claimed is:

1. A device comprising:
a first support comprising an insertion portion dimensioned to permit insertion into a first recess in a base, an extension portion extending from the insertion portion, and a connector disposed on the insertion portion;
a first key structure disposed on the connector;
a second support positioned on the second side of the base and comprising an insertion portion dimensioned for insertion into a second recess in a base, an extension portion extending from the insertion portion, and a connector disposed on the insertion portion;
a second key structure disposed on the connector;
a first mandible arm removably connected to the connector of the first support and comprising a first complementary key structure wherein the first complementary key structure is complementary to the first key structure so that the first mandible arm cannot be connected to the connector on the second support; and
a second mandible arm removably connected to the connector of the second support and comprising a second complementary key structure, wherein the second complementary key structure is complementary to the second key structure so that the second mandible arm cannot be connected to the connector on the first support.

2. The device of claim 1, further comprising the base, wherein the base comprises a top portion, an upper side, a lower side a right side and a left side, and the first recess formed in the right side and the second recess formed in the left side.

3. The device of claim 1, wherein the first and second mandible arms are positionable to be in contact with a patient's jaw at three points.

4. The device of claim 1, wherein the first and second mandible arms are positionable to provide flexion of a patient's cervical spine, extension of the patient's head, and anterior displacement of the patient's mandible.

5. The device of claim 1, wherein the first mandible arm and the second mandible arm each further comprise a mandible pad.

6. The device of claim 5, wherein the mandible pad comprises foam, plastic, or resin.

7. The device of claim 5, wherein the mandible pad is fixedly or removably affixed to the mandible arm.

8. The device of claim 1, wherein the first support is movable relative to the base and the second support is movable relative to the base.

9. The device of claim 1, wherein the first and second key structures on the mandible arms each comprise a semicircular prism extending from a body of the mandible arm and dimensioned so as to be connectable to a support structure having a receptor structure complementary to the key structure.

10. The device of claim 9, wherein the key structure further comprises an elongated ridge disposed on a flat surface of the semicircular prism.

11. The device of claim 1, further comprising a tubing grip disposed on the mandible arm.

12. The device of claim 1, wherein the first support is movable relative to the base in two axes and the second support is movable relative to the base in two axes.

13. The device of claim 1, wherein the first support is movable relative to the base in three axes and the second support is movable relative to the base in three axes.

14. The device of claim 1, wherein the first support is movable relative to the first mandible arm and the second support is movable relative to the second mandible arm.

15. A mandible arm comprising:
a curved body portion having first and second opposed surfaces, a first end and a second end;
an arm portion extending from the first surface, the arm portion comprising a semicircular prism portion dimensioned so as to be connectable to a support structure having a complementary structure; and
a mandible pad attached to the second surface of the curved body portion.

16. The mandible arm of claim 15, further comprising a key structure disposed on the arm portion, wherein the key structure is dimensioned such that the mandible arm can only be connected to a support structure having a complementary key structure.

17. The mandible aim of claim 16, wherein the key structure comprises an elongated ridge disposed on a flat surface of the semicircular prism.

18. The mandible arm of claim 16, wherein the arm portion further comprises a cylindrical projection extending from the first surface and the semicircular prism portion is disposed on and extends axially from the cylindrical projection and wherein the key structure comprises the semicircular ridge.

19. The mandible arm of claim 15, further comprising a key structure disposed on the arm portion, wherein the key structure is dimensioned such that the mandible arm can only be connected to a support structure having a complementary key structure and such that the mandible arm can only be positioned on the support structure in a predetermined orientation.

20. The mandible arm of claim 15, wherein the mandible arm is configured to be removably connected to the support structure.

21. The mandible arm of claim 15, wherein the mandible pad comprises foam, plastic, or resin.

22. The mandible aim of claim 15, wherein the mandible pad is fixedly or removably affixed to the mandible arm.

23. The mandible arm of claim 15, further comprising a tubing grip disposed on the mandible arm.

24. The mandible arm of claim 15, wherein the arm portion further comprises a cylindrical projection extending from the first surface and the semicircular prism portion is disposed on and extends axially from the cylindrical projection.

25. The mandible arm of claim 15, wherein the semicircular prism portion is further dimensioned so as to permit only selective positioning of the mandible arm relative to the support structure.
